(19) United States
(12) Patent Application Publication
(10) Pub. No.: US 2025/0260118 A1
(43) Pub. Date: Aug. 14, 2025

(54) ENERGY STORAGE APPARATUS

(71) Applicant: GS Yuasa International Ltd., Kyoto-shi (JP)

(72) Inventor: Kosuke HAYASHI, Kyoto-shi (JP)

(21) Appl. No.: 19/196,095

(22) Filed: May 1, 2025

Related U.S. Application Data
(63) Continuation of application No. PCT/JP2023/039068, filed on Oct. 30, 2023.

(30) Foreign Application Priority Data
Nov. 8, 2022 (JP) 2022-178980

(51) Int. Cl. H01M 50/291; H01M 10/658; H01M 50/209

(52) U.S. Cl. CPC H01M 50/291; H01M 10/658; H01M 50/209

(57) ABSTRACT

An energy storage apparatus includes an energy storage assembly including a spacer, first and second energy storage devices respectively positioned on one side and an other side in a first direction of the spacer main body, where the spacer includes a first wall opposed to the first energy storage device in a second direction and protruding on the one side in the first direction from the spacer main body, and a second wall opposed to the second energy storage device in the second direction and protruding on the other side in the first direction from the spacer main body, the second wall is positioned on one side in a third direction, relative to the first wall, and the energy storage assembly includes, on the other side, a first opening connecting a first space between the spacer main body and the second energy storage device with an external space.

### CROSS REFERENCE TO RELATED APPLICATIONS

This application claims the benefit of priority to Japanese Patent Application No. 2022-178980 filed on Nov. 8, 2022 and is a Continuation Application of PCT Application No. PCT/JP2023/039068 filed on Oct. 30, 2023. The entire contents of each application are hereby incorporated herein by reference.

### BACKGROUND OF THE INVENTION

### 1. Field of the Invention

The present invention relates to energy storage apparatuses that each include an energy storage device and a spacer.

### 2. Description of the Related Art

Conventionally, an energy storage apparatus that includes an energy storage device and a spacer is widely known. For example, JP 2008-277085 A discloses a battery pack (energy storage apparatus) that includes a battery block in which battery cells (energy storage devices) are stacked via spacers, and a binding band which ties and fixes the battery block. In the battery block, ventilation ducts are formed between the stacked battery cells by spacers, and the binding band is provided through penetrating through ventilation holes for blowing air for cooling to the ventilation ducts. As a result, the battery pack blows air for cooling into the ventilation holes and the ventilation ducts.

Even in an energy storage apparatus having a configuration to cool the energy storage devices, there is still a need to improve the insulative properties of the energy storage devices. However, in the energy storage apparatus disclosed in JP 2008-277085 A, the ventilation holes for cooling are provided in the binding band positioned in the lateral side of the energy storage devices, and since the lateral side of the energy storage device is exposed from the ventilation holes, there is a concern that the energy storage devices are not sufficiently insulated.

### SUMMARY OF THE INVENTION

Example embodiments of the present invention provide energy storage apparatuses in each of which the insulative properties are improved while cooling the energy storage devices.

An energy storage apparatus according to an example embodiment of the present invention includes an energy storage assembly including a spacer including a spacer main body, a first energy storage device positioned on one side in a first direction of the spacer main body, and a second energy storage device positioned on an other side in the first direction of the spacer main body, where the spacer includes a first wall opposed to the first energy storage device in a second direction intersecting the first direction, the first wall protruding on the one side in the first direction from the spacer main body, and a second wall opposed to the second energy storage device in the second direction, the second wall protruding on the other side in the first direction from the spacer main body, the second wall is positioned on one side in a third direction intersecting the first direction and the second direction, relative to the first wall, and the energy storage assembly includes, on the other side in the first direction of the first wall, a first opening which connects a first space between the spacer main body and the second energy storage device with an external space outside the energy storage assembly.

According to energy storage apparatuses of example embodiments of the present invention, insulative properties are improved while cooling the energy storage device.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a configuration of an energy storage apparatus according to an example embodiment of the present invention.

FIG. 2 is an exploded perspective view of an energy storage device and a spacer included in an energy storage assembly included in the energy storage apparatus according to an example embodiment of the present invention.

FIG. 3 is a perspective view illustrating a configuration of the energy storage device according to an example embodiment of the present invention.

FIGS. 4A and 4B are a perspective view and a front view illustrating a configuration of a spacer according to an example embodiment of the present invention.

FIGS. 5A and 5B are a perspective view and a rear view illustrating a configuration of a spacer according to an example embodiment of the present invention.

FIG. 6 is a perspective view illustrating a configuration of a spacer wall of a first spacer, a second spacer, and a third spacer, according to an example embodiment of the present invention.

FIG. 7 is a perspective view illustrating a configuration of a first spacer, a second spacer, and a third spacer in a state in which they are positioned with respect to the energy storage device, according to an example embodiment of the present invention.

FIG. 8 is a side view illustrating a configuration of a first spacer, a second spacer, and a third spacer in a state in which they are positioned with respect to the energy storage device, according to an example embodiment of the present invention.

### DETAILED DESCRIPTION OF THE EXAMPLE EMBODIMENTS

(1) An energy storage apparatus according to an example embodiment of the present invention includes an energy storage assembly including a spacer including a spacer main body, a first energy storage device positioned on one side in a first direction of the spacer main body, and a second energy storage device positioned on an other side in the first direction of the spacer main body, where the spacer includes a first wall opposed to the first energy storage device in a second direction intersecting the first direction, the first wall protruding on the one side in the first direction from the spacer main body, and a second wall opposed to the second energy storage device in the second direction, the second wall protruding on the other side in the first direction from the spacer main body, the second wall is positioned on one side in a third direction intersecting the first direction and the second direction, relative to the first wall, and the energy storage assembly includes, on the other side in the first direction of the first wall, a first opening which connects a first space between the spacer main body and the second energy storage device with an external space outside the energy storage assembly.

According to this, in the energy storage apparatus, the spacer includes a first wall opposed to the first energy storage device in the second direction, and a second wall opposed to the second energy storage device in the second direction. Accordingly, the first wall of the spacer insulates the first energy storage device in the second direction, and the second wall of the spacer insulates the second energy storage device in the second direction. The energy storage assembly includes, on the other side in the first direction of the first wall, a first opening which connects a first space between the spacer main body and the second energy storage device with an external space outside the energy storage assembly. Accordingly, the first opening can secure a flow path for a fluid that flows between a first space (internal space of the energy storage assembly) between the spacer main body and the second energy storage device, and an external space outside the energy storage assembly. As a result, the insulative properties are improved while cooling the energy storage device.

(2) In the energy storage apparatus according to the above item (1), the first wall and the second wall may be positioned at different positions in the second direction.

According to this, by positioning the first wall and the second wall of a spacer at different positions in the second direction, during assembly of the energy storage assembly, or the like, it is possible to prevent the first wall of one spacer, of the two spacers sandwiching an energy storage device, and the second wall of the other spacer from coming into contact with each other.

(3) In the energy storage apparatus according to the above (2), at least a portion of the first wall and at least a portion of the second wall may be positioned at a same position in the third direction.

According to this, by positioning at least a portion of the first wall and at least a portion of the second wall, of a spacer, at a same position in the third direction, the first wall of one spacer of the two spacers interposing an energy storage device and the second wall of an other spacer of the two spacers interposing an energy storage device can be overlapped. Accordingly, the energy storage devices can be further insulated in the second direction.

(4) In the energy storage apparatus according to any one of the above (1) to (3), a length of the first wall in the third direction may be greater than a length of the second wall in the third direction.

According to this, by making a length of the first wall of a spacer in the third direction greater than a length of the second wall in the third direction, a length in the third direction of the first opening on the other side in the first direction of the first wall can be increased. Accordingly, a flow path for a fluid that flows between the first space and the external space can be relatively large.

(5) In the energy storage apparatus according to any one of the above (1) to (4), the spacer may further include a third wall positioned on the one side in the third direction relative to the second wall, the third wall protruding on the one side in the first direction from the spacer main body and being opposed to the first energy storage device in the second direction, and the energy storage assembly further includes, on the other side in the first direction of the third wall, a second opening which connects a second space between the spacer main body and the second energy storage device with the external space.

According to this, the spacer further includes a third wall opposed to the first energy storage device in the second direction. Accordingly, the first energy storage device can be further insulated in the second direction by the third wall of the spacer. The energy storage assembly further includes, on the other side in the first direction of the third wall, a second opening which connects a second space between the spacer main body and the second energy storage device with the external space outside the energy storage assembly. Accordingly, the second opening can secure a flow path for a fluid that flows between a second space (internal space of the energy storage assembly) between the spacer main body and the second energy storage device, and an external space outside the energy storage assembly.

(6) In the energy storage apparatus according to any one of the above (1) to (5), the first wall may be positioned such that an edge thereof on the one side in the first direction overlaps the first energy storage device when viewed in the second direction.

According to this, an edge (tip end) of the first wall of the spacer on one side in the first direction overlaps the first energy storage device when viewed in the second direction, such that the first wall does not protrude from the first energy storage device. Therefore, it is possible to prevent the first wall from closing a flow path for a fluid on the one side in the first direction of the first energy storage device.

The following describes energy storage apparatuses according to example embodiments and modifications thereof, with reference to the drawings. Each of the example embodiments described below is either a comprehensive or a specific example. A numerical value, a shape, a material, an included structure, a position and a coupling configuration of the included structures, manufacturing processes, an order of manufacturing processes, and the like, which are described in the following example embodiments, are merely examples, and are not intended to limit the present invention. In the drawings, dimensions, and the like, are not strictly illustrated. In the drawings, same or similar included structural elements are assigned a same or similar reference numeral.

In the following description and in the drawings, an aligning direction in which a pair of terminals included in an energy storage device align, or a facing direction in which a pair of short side surfaces of a container of an energy storage device faces each other, or an aligning direction of the energy storage assemblies, is defined to be an X-axis direction. A facing direction in which a pair of long side surfaces of a container of an energy storage device faces each other, a thickness direction (flat direction) of a container of an energy storage device, an aligning direction in which a plurality of energy storage devices included in an energy storage assembly or a plurality of spacers align, or an aligning direction in which spacers and energy storage devices included in an energy storage assembly align, is defined to be a Y-axis direction. A protruding direction in which a terminal of an energy storage device protrudes, an aligning direction in which a container main body and a container lid portion of an energy storage device align, an aligning direction in which a case main body and a lid of a case align, a facing direction in which an opening and a bottom wall of a case main body face each other, or an up-down direction is defined as a Z-axis direction. The X-axis direction, the Y-axis direction, and the Z-axis direction are directions intersecting each other (orthogonal to each other in the present example embodiment). Although there may be a case where the Z-axis direction does not conform to the up-down direction depending on a use mode, the Z-axis direction is described as the up-down direction in the following for convenience of description.

In the following description, an X-axis positive direction indicates a direction of an arrow in the X-axis, and an X-axis negative direction indicates a direction opposite to the X-axis positive direction. When simply referred to as the X-axis direction, it indicates both or one f the X-axis positive direction and the X-axis negative direction. When referred to as one side and an other side in the X-axis direction, it indicates one and the other of the X-axis positive direction and the X-axis negative direction. The same applies to the Y-axis direction and the Z-axis direction. Hereinafter, the Y-axis direction is also referred to as a first direction, the X-axis direction is also referred to as a second direction, and the Z-axis direction is also referred to as a third direction. That is, the first direction, the second direction, and the third direction are directions intersecting each other (orthogonal to each other in the present example embodiment). Expressions indicating relative directions or postures, such as parallel and orthogonal, include cases where the directions or postures are not parallel or orthogonal in a strict sense. For example, two directions being parallel to each other means not only that the two directions are completely parallel to each other, but also that the two directions are substantially parallel to each other, in other words, a difference by several percent or so, for example, is included in the scope. In the following description, when the expression “insulative properties/insulation” is used, “insulative properties/insulation” is intended as “electrical insulative properties/electrical insulation”.

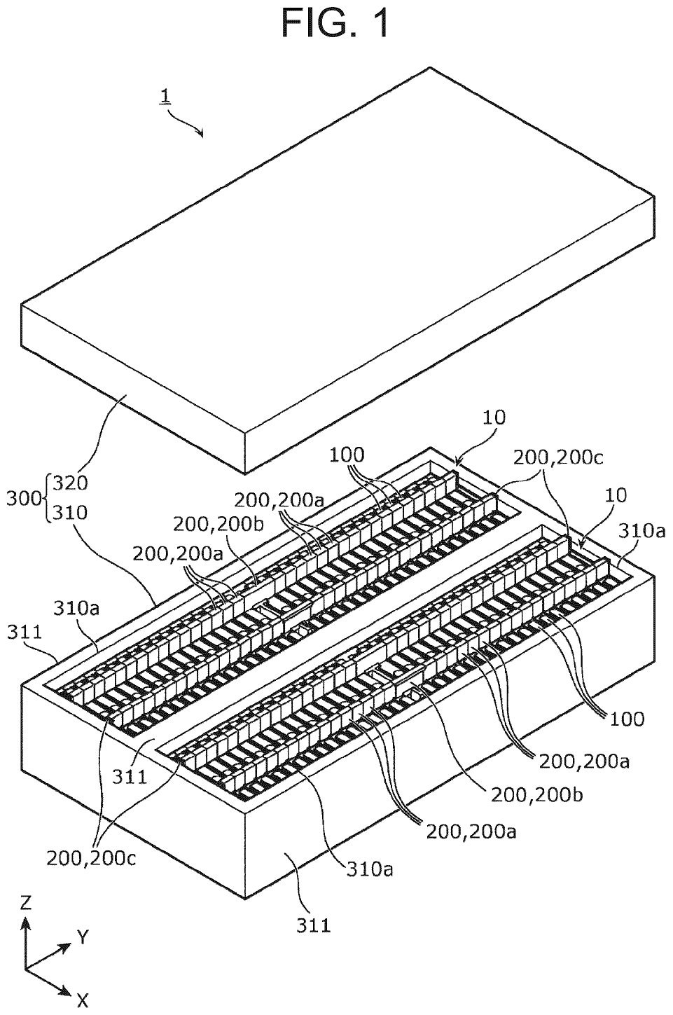

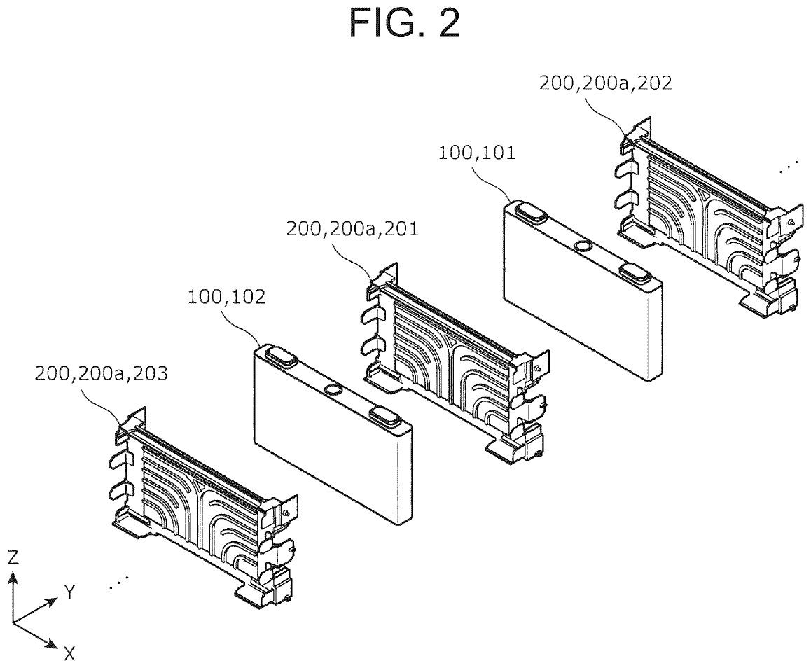

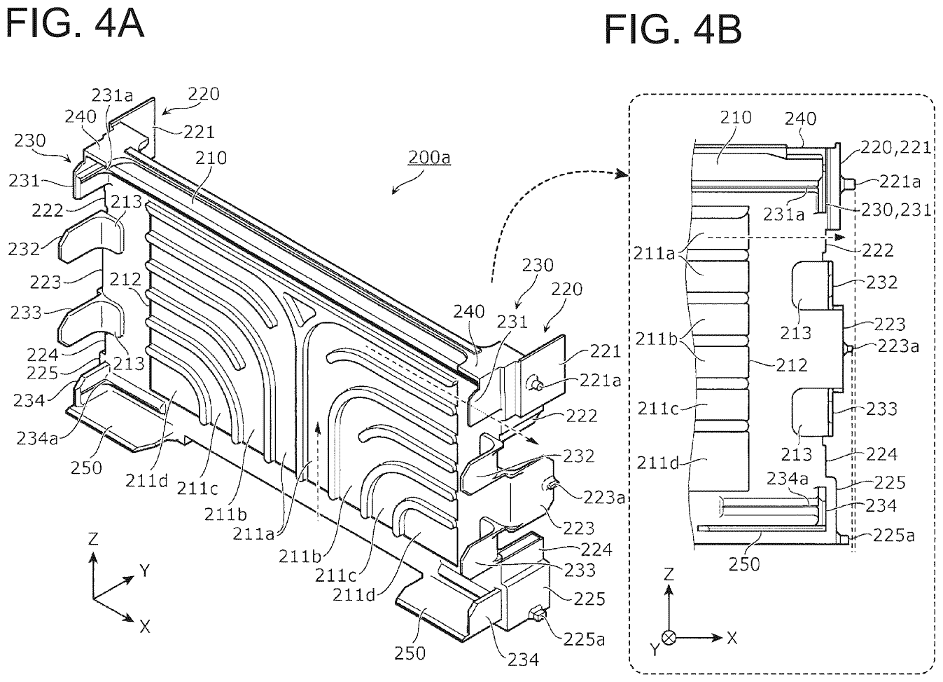

First, a schematic configuration of an energy storage apparatus 1 according to the present example embodiment is described. FIG. 1 is a perspective view illustrating a configuration of an energy storage apparatus 1 according to the present example embodiment. FIG. 1 illustrates a state in which the lid 320 is removed from the case main body 310 of the case 300 in the energy storage apparatus 1. Accordingly, two energy storage assemblies 10, positioned inside the case 300, are illustrated in FIG. 1. FIG. 2 is an exploded perspective view of an energy storage device 100 and a spacer 200 included in an energy storage assembly 10 included in the energy storage apparatus 1 according to the present example embodiment. In FIG. 2, the structural elements included in the energy storage assembly 10 are disassembled and, of them, two energy storage devices 100 and three spacers 200 (spacer 200a) are illustrated. In FIG. 1, the spacer 200a includes a portion protruding upward, whereas FIG. 2 omits illustration of that portion protruding upward from the spacer 200a, for the convenience of explanation. This applies to FIGS. 4A and 4B and subsequent drawings.

The energy storage apparatus 1 is an apparatus which can be charged with electricity from outside and can discharge electricity to outside. The energy storage apparatus 1 is used for an electric energy storage purpose, a power supply purpose, and the like. The energy storage apparatus 1 is used as a battery to drive or start an engine of movable bodies such as automobiles, motorcycles, watercrafts, ships, snowmobiles, agricultural machines, construction machines, or railway vehicles for electric railway. As the above-mentioned automobile, electric vehicles (EVs), hybrid electric vehicles (HEVs), plug-in hybrid electric vehicles (PHEVs), and fossil fuel (gasoline, light oil, liquefied natural gas, or the like) automobiles are exemplified. As the above-mentioned railway vehicles for electric railway, trains, monorails, linear induction motor trains, and hybrid trains provided with both a diesel engine and an electric motor are exemplified. The energy storage apparatus 1 can also be used as a stationary battery, or the like, for home or business, etc.

As illustrated in FIG. 1, the energy storage apparatus 1 includes an energy storage assembly 10, and a case 300 accommodating therein the energy storage assembly 10. The energy storage apparatus 1 also includes an external terminal (positive electrode external terminal and negative electrode external terminal), or the like, to electrically couple with an external apparatus, whose illustration and explanation are omitted. The energy storage apparatus 1 may include, aside from the above-described structural elements, a circuit board to monitor or control a charge state, a discharge state, or the like, of the energy storage assembly 10, an electric appliance such as a relay, etc.

The energy storage assembly 10 is a battery module (battery pack) including a plurality of energy storage devices 100. The energy storage assembly 10 includes a plurality of energy storage devices 100 positioned alternately with the spacers 200 in the Y-axis direction (first direction), to have a substantially rectangular parallelepiped shape which is long in the Y-axis direction. In the present example embodiment, two energy storage assemblies 10 positioned in the X-axis direction are accommodated inside the case 300. The energy storage assembly 10 includes a plurality of energy storage devices 100 and a plurality of spacers 200 (200a, 200b, and 200c). The energy storage assembly 10 also includes a bus bar to couple the energy storage devices 100 either in series or in parallel, a bus bar frame to hold the bus bar, a bus bar to couple the energy storage devices 100 with an external terminal, or the like, whose illustration is omitted. The bus bar may couple all the energy storage devices 100 in series, may couple some of the energy storage devices 100 in parallel and then couple the energy storage devices 100 in series, or may couple all the energy storage devices 100 in parallel. The energy storage assembly 10 is a non-restraint type module which does not include a restraint (such as an end plate and a side plate) to restrain the plurality of energy storage devices 100 and the spacers 200 in the Y-axis direction.

The energy storage device 100 is a secondary battery (a single battery) capable of charging electricity and discharging electricity, and more specifically, is a non-aqueous electrolyte secondary battery such as a lithium-ion secondary battery. The energy storage device 100 has a rectangular parallelepiped shape (square shape or square type) which is flat in the Y-axis direction. In the present example embodiment, the plurality of energy storage devices 100 are positioned in the Y-axis direction. However, the number of energy storage devices 100 provided is not particularly limited, and may be one, several tens, or even more. Additionally, the size and shape of the energy storage device 100 is not particularly limited, and may have a long cylindrical shape, an elliptical cylindrical shape, a cylindrical shape, or a polyhedral prism shape other than a rectangular parallelepiped shape. The energy storage device 100 is not limited to the non-aqueous electrolyte secondary battery, and may be a secondary battery other than the non-aqueous electrolyte secondary battery, or may be a capacitor. The energy storage device 100 does not have to be a secondary battery, and may be a primary battery from which electricity that is stored not by being charged by the user can be used. The energy storage device 100 may be a battery including a solid electrolyte. The energy storage device 100 may be a pouch-type energy storage device.

The spacer 200 is flat in the Y-axis direction, which is positioned with the energy storage device 100 in the Y-axis direction and insulates and/or thermally insulates the energy storage device 100 from other structures. The spacer 200 is an insulating plate or a thermally insulating plate which is positioned in the Y-axis positive direction or the Y-axis negative direction of the energy storage device 100, and insulates and/or thermally insulates the energy storage devices 100 from each other or the energy storage device 100 from the case 300. The spacer 200 includes walls on both sides of the energy storage device 100 in the X-axis direction and both sides of the energy storage device 100 in the Z-axis direction, thus also having a function of a holder to hold the energy storage device 100 and to position the energy storage device 100. The spacer 200 is provided with a flow path through which a refrigerant (fluid such as air) flows, and also has a function of cooling the energy storage device 100.

The spacer 200 may include polycarbonate (PC), polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), or ABS resin, or alternatively, an insulating material such as a composite material thereof, or a material having heat insulative properties, such as mica, or the like.

Hereinafter, the spacer 200 positioned at the central position of the energy storage assembly 10 in the Y-axis direction (between the two energy storage devices 100 at the central position) is also referred to as a spacer 200b. The spacers 200 positioned at both ends of the energy storage assembly 10 in the Y-axis direction (between the energy storage devices 100 at the ends and the case 300) are also referred to as spacers 200c. The spacer 200 positioned between the spacer 200b and the spacer 200c (between two energy storage devices 100 other than those at the central position) is also referred to as a spacer 200a. The spacers 200 (spacer 200a, 200b, and 200c) are positioned alternately with the energy storage devices 100. Although FIG. 2 illustrates a configuration in which the energy storage devices 100 and the spacers 200a are alternately positioned, the spacers 200a, and the spacers 200b and 200c, are alternately positioned with the energy storage devices 100.

To be more specific, as illustrated in FIG. 2, the spacer 200a is an intermediate spacer (intermediate holder) which includes walls on both sides in the X-axis direction and both sides in the Z-axis direction of two energy storage devices 100 positioned on both sides of the spacer 200a in the Y-axis direction, and holds the two energy storage devices 100. Similarly, the spacer 200b is a center plate (center spacer or center holder) which includes walls on both sides in the X-axis direction and both sides in the Z-axis direction of two energy storage devices 100 positioned on both sides of the spacer 200b in the Y-axis direction, and holds the two energy storage devices 100. The spacer 200b increases the rigidity of the energy storage assembly 10 which is long in the Y-axis direction. The spacer 200c is an end spacer (end holder) which includes walls on both sides in the X-axis direction and both sides in the Z-axis direction of one energy storage device 100 positioned on one side in the spacer 200c in the Y-axis direction, and holds the one energy storage device 100.

That is, the energy storage device 100 positioned at the central portion of the energy storage assembly 10 in the Y-axis direction is held by a spacer 200a and a spacer 200b. The energy storage device 100 positioned at an end of the energy storage assembly 10 in the Y-axis direction is held by the spacer 200a and the spacer 200c. The other energy storage devices 100 are each held by two spacers 200a. All of the spacers 200 (spacers 200a, 200b, and 200c) may be made of a same material, or any of the spacers 200 may be made of a different material.

The case 300 is a container in a substantially rectangular parallelepiped shape (box shape), defining an outer body (outer shell) of the energy storage apparatus 1. The case 300 is positioned outside the energy storage assembly 10, fixes the energy storage assembly 10 in a predetermined position, and protects the energy storage assembly 10 from shocks, etc. The case 300 is a metal case made of metal, such as aluminum, an aluminum alloy, stainless steel, iron, and a plated steel plate. In the present example embodiment, the case 300 is formed by die casting aluminum (aluminum die casting).

As illustrated in FIG. 1, the case 300 includes a case main body 310 defining a main body of the case 300, and a lid 320 defining a lid of the case 300. The case main body 310 is a housing (casing) in which an opening 310a is provided in the Z-axis positive direction (one side in the third direction), and accommodates therein the energy storage assembly 10 (the energy storage devices 100 and the spacers 200 (the spacers 200a, 200b, and 200c)). The lid 320 has a flat rectangular shape which closes an opening 310a of the case main body 310. The case main body 310 includes two rectangular openings 310a positioned in the X-axis direction, and after the energy storage assembly 10 is inserted from each opening 310a, the case main body 310 and the lid 320 are joined together by fastening using bolts or the like, welding, adhesive bonding, or the like. Accordingly, the case 300 has a sealed (airtight) structure. As described above, the case 300 (the case main body 310) includes the case walls 311 in the X-axis positive direction (one side in a second direction intersecting the first direction) and the X-axis negative direction (an other side in the second direction) of the energy storage assembly 10. The case wall 311 is a plate-shaped wall which is opposed to the energy storage assembly 10 in the X-axis direction, is parallel to the YZ plane, and extends in the Y-axis direction. To the case main body 310 or the lid 320, a terminal block for the external terminal (the positive electrode external terminal and the negative electrode external terminal) may be mounted, and the external terminal may be positioned on the terminal block.

Next, configurations of the energy storage device 100 and the spacer 200a are described in detail.

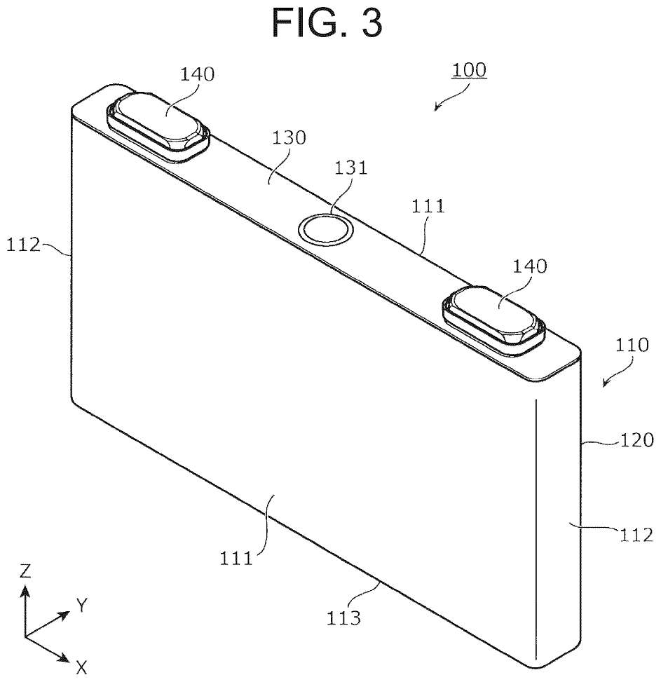

FIG. 3 is a perspective view illustrating a configuration of the energy storage device 100 according to the present example embodiment. FIG. 3 illustrates an enlarged view of the energy storage device 100 illustrated in FIG. 2. Since the plurality of energy storage devices 100 included in the energy storage assembly 10 all have the same configuration, FIG. 3 illustrates one energy storage device 100, and the configuration of one energy storage device 100 is described in detail below.

As illustrated in FIG. 3, the energy storage device 100 includes a container 110, and a pair of (positive and negative) terminals 140. An electrode body, a pair of (positive electrode and negative electrode) current collectors, and an electrolyte solution (non-aqueous electrolyte) are accommodated inside the container 110, and a gasket is positioned between the terminal 140 and the current collector, and the container 110. However, these are not illustrated in the drawings. This electrolyte solution may be of any type as long as it does not impair the performance of the energy storage device 100, and may be selected from various alternatives. The gasket may include any material as long as it has insulative properties. The energy storage device 100 may include, aside from the above-described structural elements, a spacer to be positioned on a side of the electrode body, an insulating film to wrap around the electrode body, or the like, and an insulating film (e.g. shrink tube), or the like, to cover an outer surface of the container 110.

The container 110 is a case having a rectangular parallelepiped shape (a square shape or a box shape), the case including a container main body 120 including an opening and a container lid portion 130 that closes the opening of the container main body 120. The container main body 120 has a rectangular cylindrical shape and includes a bottom, which defines a main body portion of the container 110, and includes an opening on the Z-axis positive direction side. The container lid portion 130 is a plate-shaped structure with a rectangular shape, which is long in the X-axis direction, defining a lid portion of the container 110. The container lid portion 130 is positioned in the Z-axis positive direction of the container main body 120. The container lid portion 130 is provided with a gas exhaust valve 131 to release pressure inside the container 110 in case the pressure is raised excessively, a liquid injection portion (not illustrated) inside the container 110 to inject the electrolyte solution, and the like. The material of the container 110 (the container main body 120 and the container lid portion 130) is not particularly limited. For example, while a weldable (joinable) metal such as stainless steel, aluminum, an aluminum alloy, iron, or a plated steel plate can be used, a resin can also be used.

The container 110 is sealed and is airtight as a result of joining the container main body 120 and the container lid portion 130 by welding or the like, after an electrode body, or the like, is accommodated inside the container main body 120. The container 110 includes a pair of long side surfaces 111 on side surfaces on both sides in the Y-axis direction, a pair of short side surfaces 112 on side surfaces on both sides in the X-axis direction, and a bottom surface 113 on the Z-axis negative direction side. The long side surface 111 is a rectangular planar portion that defines a long side surface of the container 110, and is opposed to an adjacent spacer 200 in the Y-axis direction. The long side surfaces 111 are adjacent to the short side surfaces 112 and the bottom surface 113, and are larger than the short side surfaces 112. The short side surface 112 is a rectangular planar portion that defines a short side surface of the container 110, and is opposed to a wall of the spacer 200 and the case 300 in the X-axis direction. The short side surfaces 112 are adjacent to the long side surfaces 111 and the bottom surface 113, and are smaller than the long side surfaces 111. The bottom surface 113 is a rectangular planar portion that defines a bottom surface of the container 110, and is opposed to a wall of the spacer 200 and the bottom wall of the case 300 in the Z-axis direction. The bottom surface 113 is positioned adjacent to the long side surfaces 111 and the short side surfaces 112.

The terminals 140 are electrode terminals (positive electrode terminal and negative electrode terminal) of the energy storage device 100, and are positioned on the container lid portion 130. Specifically, the terminals 140 protrude from an upper surface (terminal placement surface) of the container lid portion 130 towards the Z-axis positive direction. The terminals 140 are electrically coupled to a positive electrode plate and a negative electrode plate of the electrode body via the current collector. Namely, the terminal 140 is a metal structure to lead out electricity stored in the electrode body to an external space of the energy storage device 100 and to introduce electricity into the internal space of the energy storage device 100 in order to store the electricity in the electrode body. The terminal 140 is made of aluminum, an aluminum alloy, copper, a copper alloy, or the like.

The electrode body is an energy storage component (power generating component) constructed preferably by stacking a positive electrode plate, a negative electrode plate, and a separator. The positive electrode plate is made by forming a positive electrode active material layer on a positive electrode base material layer being current collector foil made of metal such as aluminum or an aluminum alloy. The negative electrode plate is made by forming a negative electrode active material layer on a negative electrode base material layer being current collector foil made of metal such as copper or a copper alloy. The active material used for the positive electrode active material layer and the negative electrode active material layer may be any known material as long as it can store and discharge lithium ions. As the separator, a microporous sheet, nonwoven fabric, or the like, made of resin may be used. In the present example embodiment, the electrode body is constructed preferably by stacking polar plates (a positive electrode plate and a negative electrode plate) in the Y-axis direction. The electrode body may be any type of electrode body such as a wound electrode body constructed preferably by winding a polar plate (a positive electrode plate and a negative electrode plate), a stacked-layer type (stack type) electrode body constructed preferably by stacking a plurality of plate-shaped electrode plates, or a bellows-type electrode body constructed preferably by folding an electrode plate in a bellows style.

The current collector is a conductive current collector member (positive electrode current collector and negative electrode current collector), which is either electrically or mechanically coupled to the terminal 140 and the electrode body. The positive electrode current collector is made of aluminum or an aluminum alloy, etc. just as the positive electrode base material layer of the positive electrode plate of the electrode body. The negative electrode current collector is made of copper or a copper alloy, etc. just as the negative electrode base material layer of the negative electrode plate of the electrode body.

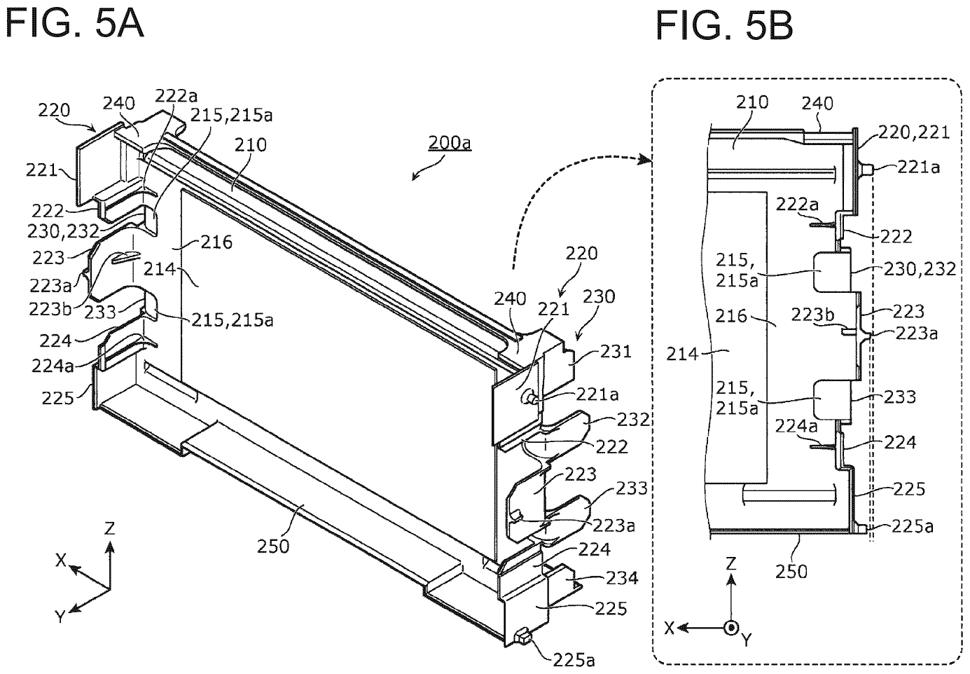

Next, a configuration of the spacer 200a is described in detail. FIGS. 4A and 4B are a perspective view and a front views illustrating a configuration of the spacer 200a according to the present example embodiment. Specifically, FIG. 4A is an enlarged perspective view illustrating the spacer 200a illustrated in FIG. 2. FIG. 4B is a front view illustrating a configuration when an end of the spacer 200a illustrated in FIG. 4A in the X-axis positive direction is viewed from the Y-axis negative direction. FIGS. 5A and 5B are a perspective view and a rear view illustrating a configuration of the spacer 200a according to the present example embodiment. Specifically, FIG. 5A is a perspective view illustrating a configuration on an opposite side of the spacer 200a illustrated in FIG. 4A (a configuration when viewed from the Y-axis positive direction). FIG. 5B is a rear view illustrating a configuration when an end of the spacer 200a illustrated in FIG. 5A in the X-axis negative direction is viewed from the Y-axis positive direction. Since all of the plurality of spacers 200a included in the energy storage assembly 10 have the same configuration, one spacer 200a is illustrated in FIGS. 4A, 4B, 5A, and 5B, and the configuration of one spacer 200a is described in detail below.

As illustrated in FIGS. 4A, 4B, 5A, and 5B, both ends of the spacer 200a in the X-axis direction have similar shapes. That is, the spacer 200a has a shape symmetrical with respect to a plane passing through the center position and parallel to the YZ plane. The spacer 200a includes a spacer main body 210 and spacer walls 220 to 250.

The spacer main body 210 is a plate-shaped and rectangular portion defining a main body portion of the spacer 200a, and is parallel to an XZ plane. In the present example embodiment, the spacer main body 210 is opposed to the long side surface 111 in the Y-axis direction and is in contact with the long side surface 111, so as to cover the entire surface of the long side surface 111 of the container 110 of the energy storage device 100, in the Y-axis positive direction or the Y-axis negative direction of the energy storage device 100.

As illustrated in FIGS. 4A and 4B, spaces 211a to 211d are each provided on a surface of the spacer main body 210 in the Y-axis negative direction. The spaces 211a to 211d are each a space positioned between the spacer main body 210 and the energy storage device 100 when the spacer 200a and the energy storage device 100 positioned in the Y-axis negative direction of the spacer 200a (the spacer main body 210) are assembled. The spaces 211a to 211d are flow paths for a fluid that flows between the spacer main body 210 and the energy storage device 100. The fluid that flows through the spaces 211a to 211d is a fluid (refrigerant) to cool the energy storage device 100, such as a gas such as air, or a liquid. The spaces 211a to 211d are each also used as a space into which a jig is inserted when the energy storage device 100 is held during manufacturing (during assembly work).

In the present example embodiment, the spaces 211a to 211d are each a space in an L-shaped groove portion defined by a plurality of ribs provided on a surface of the spacer main body 210 in the Y-axis negative direction and curved in an L-shape, and is curved in an L-shape along the spacer main body 210. Specifically, a concave portion 212 recessed in the Y-axis positive direction is provided on a surface of the spacer main body 210 in the Y-axis negative direction. The concave portion 212 is a large concave portion which occupies most of a region of a surface of the spacer main body 210 in the Y-axis negative direction and has a rectangular shape when viewed in the Y-axis direction. A plurality of ribs are provided in the concave portion 212, thus providing spaces 211a to 211d.

The space 211a is elongated in the Z-axis positive direction from a central portion in the X-axis direction at an end of the spacer main body 210 in the Z-axis negative direction, and is curved in the X-axis direction to elongate in the X-axis direction. To be specific, two spaces 211a positioned in the X-axis direction elongate in the Z-axis positive direction, and are curved toward both sides in the X-axis direction to elongate to both sides in the X-axis direction. In the present example embodiment, each space 211a is curved in the X-axis direction and then divided into two spaces, and the two spaces merge at an end of the spacer main body 210 in the X-axis direction.

The space 211b is a space elongated in the Z-axis positive direction from outside in the X-axis direction of a space 211a at an end of the spacer main body 210 in the Z-axis negative direction, and is curved in the X-axis direction to elongate in the X-axis direction. To be specific, two spaces 211b elongate in the Z-axis positive direction from positions sandwiching two spaces 211a at an end of the spacer main body 210 in the Z-axis negative direction, and are curved toward both sides in the X-axis direction to elongate to both sides in the X-axis direction. In the present example embodiment, each space 211b is curved in the X-axis direction and then divided into two spaces, and the two spaces merge at an end of the spacer main body 210 in the X-axis direction.

The space 211c is a space elongated in the Z-axis positive direction from outside in the X-axis direction of a space 211b portion at an end of the spacer main body 210 in the Z-axis negative direction, and is curved in the X-axis direction to elongate in the X-axis direction. To be specific, two spaces 211c elongate in the Z-axis positive direction from positions sandwiching two spaces 211b at an end of the spacer main body 210 in the Z-axis negative direction, and are curved toward both sides in the X-axis direction to elongate to both sides in the X-axis direction. The space 211d is a space elongated in the X-axis direction from outside in the X-axis direction of a space 211c at an end of the spacer main body 210 in the Z-axis negative direction. To be specific, two spaces 211d elongate to both sides in the X-axis direction from positions sandwiching two space 211c at an end of the spacer main body 210 in the Z-axis negative direction.

As illustrated in FIGS. 5A and 5B, the spacer main body 210 includes a first surface 214, a second surface 215, and a third surface 216, which are provided on a surface thereof in the Y-axis positive direction.

The first surface 214 is a large plane (flat surface) having a rectangular shape when viewed in the Y-axis direction, and occupies most of a region of a surface of the spacer main body 210 in the Y-axis positive direction. The first surface 214 is larger than the second surface 215 and is larger than the third surface 216. The first surface 214 is opposed to the energy storage device 100 positioned in the Y-axis positive direction of the spacer 200a (the spacer main body 210). The first surface 214 is opposed to the long side surface 111 in the Y-axis direction and in contact with the long side surface 111, so as to cover most of a region of the long side surface 111 of the container 110 of the energy storage device 100. The first surface 214 protrudes from the third surface 216 in the Y-axis positive direction, such that the first surface 214 protrudes more in the Y-axis positive direction than the second surface 215 and the third surface 216. The first surface 214 is positioned on the rear side of the above-described concave portion 212 in the spacer main body 210 (in a position overlapping the concave portion 212 when viewed in the Y-axis direction). That is, the surface of the spacer main body 210 in the Y-axis positive direction protrudes in the Y-axis positive direction so as to provide the first surface 214, such that the surface of the spacer main body 210 in the Y-axis negative direction is recessed in the Y-axis positive direction to define the concave portion 212.

The third surface 216 is recessed relative to the first surface 214, on a surface of the spacer main body 210 in the Y-axis positive direction. The third surface 216 is a plane (flat surface) recessed from the first surface 214 in the Y-axis negative direction so as to surround the periphery of the first surface 214. The third surface 216 is a rectangular annular surface positioned on the outer circumference of the spacer main body 210 when viewed in the Y-axis direction, so as to surround the entire circumference of the first surface 214 on both sides in the X-axis direction and on both sides in the Z-axis direction.

The second surface 215 is positioned in the X-axis direction (a second direction intersecting the first direction) of the first surface 214, and is recessed relative to the first surface 214. Specifically, the second surface 215 is recessed relative to the third surface 216. The second surface 215 is recessed from the third surface 216 in the Y-axis negative direction, at an end of the third surface 216 in the X-axis direction. The size and shape of the second surface 215 are not particularly limited. However, in the present example embodiment, the second surface 215 is smaller than the third surface 216. The second surface 215 includes a plane (flat surface) which is recessed from the third surface 216 in the Y-axis negative direction and is long in the Z-axis direction, and a curved surface which is curved toward the Y-axis negative direction as it goes outward in the X-axis direction (i.e., towards an edge of the spacer main body 210 in the X-axis direction). In the present example embodiment, two second surfaces 215 positioned in the Z-axis direction are provided on each of both sides of the spacer main body 210 in the X-axis direction.

The second surface 215 is positioned corresponding to walls 232 and 233 to be described later. Specifically, the second surface 215 is defined by a surface in the Y-axis positive direction at a base of the walls 232 and 233 (a coupling portion to the spacer main body 210) being recessed in the Y-axis negative direction. Accordingly, as illustrated in FIGS. 4A and 4B, a surface in the Y-axis negative direction at a base of the walls 232 and 233 protrudes in the Y-axis negative direction to define protruding portions 213. Four protruding portions 213 are provided at positions corresponding to bases of the walls 232 and 233 on the surface of a spacer main body 210 in the Y-axis negative direction. The protruding portion 213 has a shape in which a surface in the Y-axis negative direction is along the second surface 215 (a shape having a plane which is long in the Z-axis direction and a curved surface which is curved in the Y-axis negative direction as it extends toward outside in the X-axis direction).

Since the second surface 215 is recessed from the third surface 216, a space 215a is provided at the position of the second surface 215. The space 215a is a space positioned between the second surface 215 and the energy storage device 100 when the spacer 200a and the energy storage device 100 positioned in the Y-axis positive direction of the spacer 200a (the spacer main body 210) are assembled. The space 215a is a space into which a jig is inserted when the energy storage device 100 is held during manufacturing (during assembly work). Unlike the above-described spaces 211a to 211d, the space 215a is not a flow path for a fluid that flows between the spacer main body 210 and the energy storage device 100.

The spacer wall 220 is a portion protruding in the Y-axis positive direction from an end of the spacer main body 210 in the X-axis direction, and includes walls 221 to 225. The walls 221 to 225 are a plurality of plate-shaped walls parallel to the YZ plane, which are positioned at respectively different positions in the Z-axis direction, and positioned in the Z-axis direction toward the Z-axis negative direction in this order. The spacer wall 220 (the walls 221 to 225) is positioned along the short side surface 112 of the container 110 of the energy storage device 100 positioned in the Y-axis positive direction of the spacer main body 210, to be opposed to the short side surface 112 in the X-axis direction. The spacer wall 220 (the walls 221 to 225) is opposed to the case wall 311 (refer to FIG. 1) of the case 300 (the case main body 310). The spacer wall 220 (the walls 221 to 225) is positioned by being separated (with a gap) from the case wall 311. In the present example embodiment, two spacer walls 220 (two sets of walls 221 to 225) are positioned at both ends of the spacer main body 210 in the X-axis direction.

The spacer wall 230 is a portion protruding in the Y-axis negative direction from an end of the spacer main body 210 in the X-axis direction, and includes walls 231 to 234. The walls 231 to 234 are a plurality of plate-shaped walls parallel to the YZ plane, which are positioned at respectively different positions in the Z-axis direction, and position in the Z-axis direction toward the Z-axis negative direction in this order. The spacer wall 230 (the walls 231 to 234) is positioned along the short side surface 112 of the container 110 of the energy storage device 100 positioned in the Y-axis negative direction of the spacer main body 210, to be opposed to the short side surface 112 in the X-axis direction. The spacer wall 230 (the walls 231 to 234) is opposed to the case wall 311 (refer to FIG. 1) of the case 300 (the case main body 310). The spacer wall 230 (the walls 231 to 234) is positioned to be separated (with a gap) from the case wall 311. In the present example embodiment, two spacer walls 230 (two sets of walls 231 to 234) are positioned at both ends of the spacer main body 210 in the X-axis direction.

The spacer wall 240 is a plate-shaped portion protruding from an end of the spacer main body 210 in the Z-axis positive direction to both sides in the Y-axis direction, and is parallel to the XY plane. The spacer walls 240 are opposed to the container lid portions 130 in the Z-axis direction, along the container lid portions 130 of the containers 110 of the energy storage devices 100 positioned on both sides of the spacer main body 210 in the Y-axis direction. The spacer wall 250 is a plate-shaped portion protruding from an end of the spacer main body 210 in the Z-axis negative direction to both sides in the Y-axis direction, and is parallel to the XY plane. The spacer walls 250 are positioned along the bottom surfaces 113 of the containers 110 of the energy storage devices 100 positioned on both sides of the spacer main body 210 in the Y-axis direction, to be opposed to the bottom surfaces 113 in the Z-axis direction.

As described above, the spacer walls 220 to 250 are positioned to cover both sides of the energy storage device 100 in the X-axis direction and both sides thereof in the Z-axis direction. Accordingly, the spacer 200a holds the energy storage device 100.

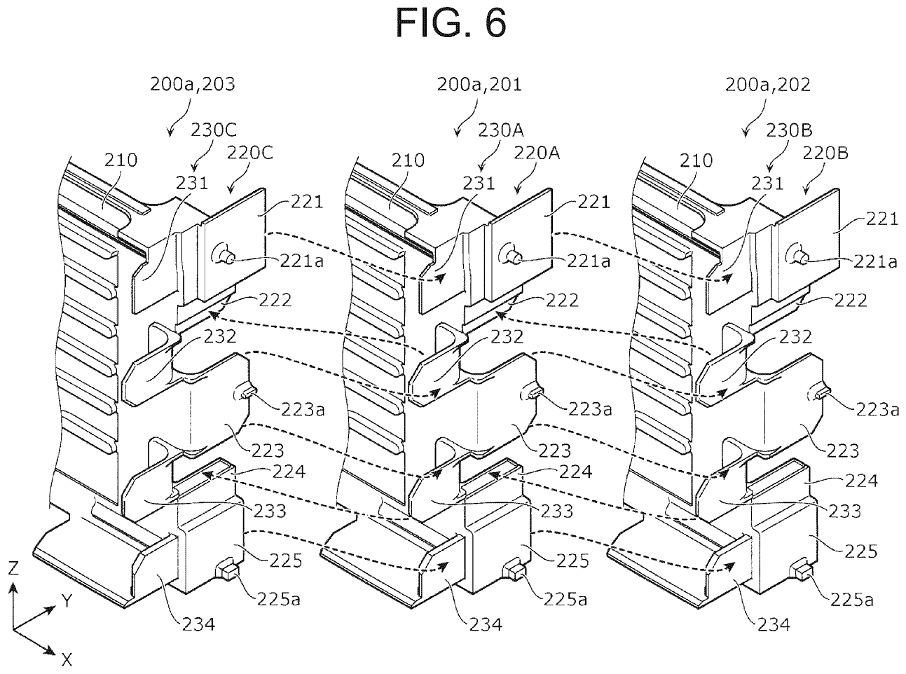

Hereinafter, a configuration of the spacer wall 220 (the walls 221 to 225) and the spacer wall 230 (the walls 231 to 234) is described in more detail with reference to FIG. 6 to FIG. 8. In this description, hereinafter, as illustrated in FIG. 2, among the three spacers 200a positioned in the Y-axis direction, the spacer 200a positioned at the center is also referred to as a first spacer 201. The spacer 200a positioned in the Y-axis positive direction of the first spacer 201 is also referred to as a second spacer 202. The spacer 200a positioned in the Y-axis negative direction of the first spacer 201 is also referred to as a third spacer 203. The first spacer 201, the second spacer 202, and the third spacer 203 have the same configuration.

The energy storage device 100 positioned between the first spacer 201 and the second spacer 202 is also referred to as a first energy storage device 101. The energy storage device 100 positioned between the first spacer 201 and the third spacer 203 is also referred to as a second energy storage device 102. That is, the energy storage device 100 positioned in the Y-axis positive direction (one side in the first direction) of the spacer main body 210 of the first spacer 201 is also referred to as a first energy storage device 101. The energy storage device 100 positioned in the Y-axis negative direction (an other side in the first direction) of the spacer main body 210 of the first spacer 201 is also referred to as a second energy storage device 102. The first energy storage device 101 and the second energy storage device 102 have the same configuration. As described above, the second spacer 202, the first energy storage device 101, the first spacer 201, the second energy storage device 102, and the third spacer 203 are positioned in this order from the Y-axis positive direction.

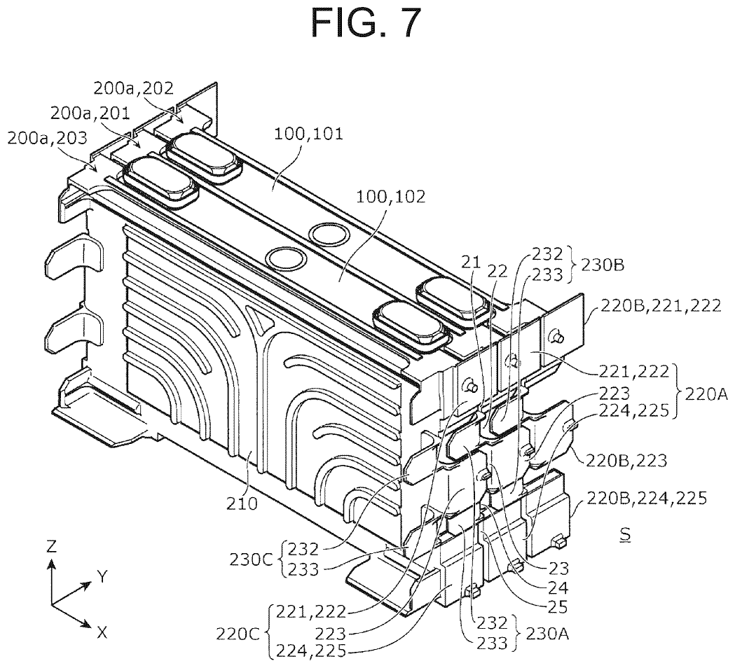

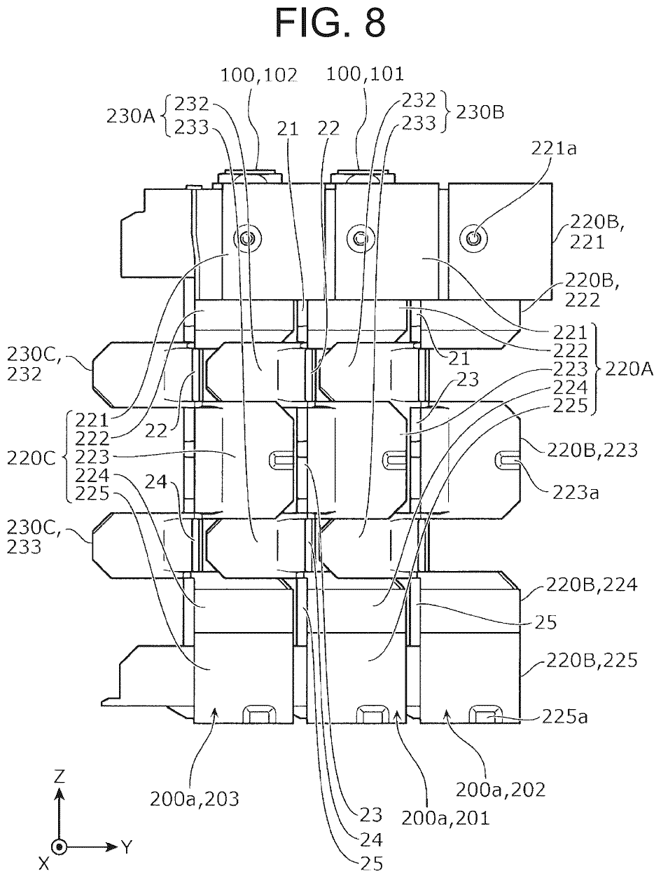

FIG. 6 is a perspective view illustrating a configuration of the spacer walls 220 and 230 of the first spacer 201, the second spacer 202, and the third spacer 203 according to the present example embodiment. FIG. 6 illustrates a configuration of an end in the X-axis positive direction of the first spacer 201, the second spacer 202, and the third spacer 203 positioned in the Y-axis direction. FIG. 7 is a perspective view illustrating a configuration in a state in which the first spacer 201, the second spacer 202, and the third spacer 203 according to the present example embodiment are positioned with respect to the energy storage device 100. FIG. 7 illustrates a state in which the first energy storage device 101 and the second energy storage device 102 are positioned between the first spacer 201, the second spacer 202, and the third spacer 203, respectively. FIG. 8 is a side view illustrating a configuration in a state in which the first spacer 201, the second spacer 202, and the third spacer 203 according to the present example embodiment are positioned with respect to the energy storage device 100. FIG. 8 illustrates the configuration in FIG. 7 viewed from the X-axis positive direction.

An end of the first spacer 201, the second spacer 202, and the third spacer 203 in the X-axis positive direction and an end thereof in the X-axis r direction have the same configuration. Therefore, hereinafter, configurations of ends of the first spacer 201, the second spacer 202, and the third spacer 203 in the X-axis positive direction are described in detail, whereas descriptions of configurations of ends thereof in the X-axis negative direction are omitted. That is, the configurations of the ends of the first spacer 201, the second spacer 202, and the third spacer 203 in the X-axis negative direction are obtained by replacing “X-axis negative direction” in the description of the configuration of the end in the X-axis positive direction, which are described later, with “X-axis positive direction”, and replacing “X-axis positive direction” with “X-axis negative direction”.

As illustrated in FIG. 6 to FIG. 8, the first spacer 201, the second spacer 202, and the third spacer 203 respectively include spacer walls 220 and 230. The spacer walls 220 and 230 included in the first spacer 201 are referred to as first spacer walls 220A and 230A. The spacer walls 220 and 230 included in the second spacer 202 are referred to as second spacer walls 220B and 230B. The spacer walls 220 and 230 included in the third spacer 203 are referred to as third spacer walls 220C and 230C. The first spacer wall 220A protrudes in the Y-axis positive direction toward the second spacer 202, and the first spacer wall 230A protrudes in the Y-axis negative direction toward the third spacer 203. The second spacer wall 230B protrudes in the Y-axis negative direction toward the first spacer 201. The third spacer wall 220C protrudes toward the first spacer 201 in the Y-axis positive direction. The first spacer wall 220A, the second spacer wall 220B, and the third spacer wall 220C respectively include walls 221 to 225. The first spacer wall 230A, the second spacer wall 230B, and the third spacer wall 230C respectively include walls 231 to 234.

The wall 221 is a plate-shaped wall parallel to the YZ plane, protruding in the Y-axis positive direction from an end in the Z-axis positive direction at an end of the spacer main body 210 in the X-axis positive direction. The wall 231 is a plate-shaped wall parallel to the YZ plane, protruding in the Y-axis negative direction from an end in the Z-axis positive direction at an end of the spacer main body 210 in the X-axis positive direction. The wall 221 is opposed to the energy storage device 100 positioned in the Y-axis positive direction of the spacer main body 210 and the case wall 311 (refer to FIG. 1) of the case 300 (the case main body 310), in the X-axis direction. The wall 231 is opposed to the energy storage device 100 positioned in the Y-axis negative direction of the spacer main body 210 and the case wall 311, in the X-axis direction. In the first spacer 201, the wall 221 of the first spacer wall 220A is opposed to the first energy storage device 101 in the X-axis direction, and the wall 231 of the first spacer wall 230A is opposed to the second energy storage device 102 in the X-axis direction. The same applies to the second spacer 202 and the third spacer 203.

The wall 221 and the wall 231 are positioned at different positions in the X-axis direction, and at least a portion thereof is positioned at the same position in the Z-axis direction. Specifically, the wall 221 is positioned in the X-axis positive direction relative to the wall 231, and is positioned at substantially the same position as the wall 231 in the Z-axis direction. Accordingly, the wall 221 of the first spacer wall 220A is positioned in the X-axis positive direction of the wall 231 of the second spacer wall 230B, and overlaps with the wall 231 in the X-axis direction. The same applies to the wall 221 of the third spacer wall 220C and the wall 231 of the first spacer wall 230A.

The wall 225 is a plate-shaped wall parallel to the YZ plane, protruding in the Y-axis positive direction from an end of the spacer main body 210 in the Z-axis negative direction, at an end of the spacer main body 210 in the X-axis positive direction. The wall 234 is a plate-shaped wall parallel to the YZ plane, protruding in the Y-axis negative direction from an end of the spacer main body 210 in the Z-axis negative direction, at an end of the spacer main body 210 in the X-axis positive direction. The wall 225 is opposed to the energy storage device 100 positioned in the Y-axis positive direction of the spacer main body 210 and the case wall 311, in the X-axis direction. The wall 234 is opposed to the energy storage device 100 positioned in the Y-axis negative direction of the spacer main body 210 and the case wall 311, in the X-axis direction. In the first spacer 201, the wall 225 of the first spacer wall 220A is opposed to the first energy storage device 101 in the X-axis direction, and the wall 234 of the first spacer wall 230A is opposed to the second energy storage device 102 in the X-axis direction. The same applies to the second spacer 202 and the third spacer 203.

The wall 225 and the wall 234 are positioned at different positions in the X-axis direction, and at least a portion thereof is positioned at the same position in the Z-axis direction. Specifically, the wall 225 is positioned in the X-axis positive direction relative to the wall 234, and is positioned at substantially the same position as the wall 234 in the Z-axis direction. Accordingly, the wall 225 of the first spacer wall 220A is positioned in the X-axis positive direction of the wall 234 of the second spacer wall 230B, and overlaps with the wall 234 in the X-axis direction. The same applies to the wall 225 of the third spacer wall 220C and the wall 234 of the first spacer wall 230A.

The wall 222 is a plate-shaped wall parallel to the YZ plane, protruding in the Y-axis positive direction from a position in the Z-axis negative direction relative to the wall 221 at an end of the spacer main body 210 in the X-axis positive direction. In the present example embodiment, the wall 222 is coupled (continuously connected) to the wall 221. However, the wall 222 may be positioned to be spaced apart from the wall 221. The wall 222 is opposed to the energy storage device 100 positioned in the Y-axis positive direction of the spacer main body 210 and the case wall 311, in the X-axis direction. In the first spacer 201, the wall 222 of the first spacer wall 220A is opposed to the first energy storage device 101 in the X-axis direction, and in the third spacer 203, the wall 222 of the third spacer wall 220C is opposed to the second energy storage device 102 in the X-axis direction. The same applies to the second spacer 202.

The wall 224 is a plate-shaped wall parallel to the YZ plane, protruding in the Y-axis positive direction from a position in the Z-axis positive direction relative to the wall 225 at an end of the spacer main body 210 in the X-axis positive direction. In the present example embodiment, the wall 224 is coupled (continuously connected) to the wall 225. However, the wall 224 may be positioned to be spaced apart from the wall 225. The wall 224 is opposed to the energy storage device 100 positioned in the Y-axis positive direction of the spacer main body 210 and the case wall 311, in the X-axis direction. In the first spacer 201, the wall 224 of the first spacer wall 220A is opposed to the first energy storage device 101 in the X-axis direction, and in the third spacer 203, the wall 224 of the third spacer wall 220C is opposed to the second energy storage device 102 in the X-axis direction. The same applies to the second spacer 202.

The wall 223 is a plate-shaped wall parallel to the YZ plane, protruding in the Y-axis positive direction from a central portion in the Z-axis direction at an end of the spacer main body 210 in the X-axis positive direction. The wall 223 is opposed to the energy storage device 100 positioned in the Y-axis positive direction of the spacer main body 210 and the case wall 311, in the X-axis direction. In the first spacer 201, the wall 223 of the first spacer wall 220A is opposed to the first energy storage device 101 in the X-axis direction, and in the third spacer 203, the wall 223 of the third spacer wall 220C is opposed to the second energy storage device 102 in the X-axis direction. The same applies to the second spacer 202.

The wall 232 is a plate-shaped wall parallel to the YZ plane, protruding in the Y-axis negative direction from a position at an end of the spacer main body 210 in the X-axis positive direction, that is in the Z-axis negative direction relative to the wall 222 and in the Z-axis positive direction relative to the wall 223. The wall 232 is opposed to the energy storage device 100 positioned in the Y-axis negative direction of the spacer main body 210 and the case wall 311, in the X-axis direction. In the first spacer 201, the wall 232 of the first spacer wall 230A is opposed to the second energy storage device 102 in the X-axis direction, and in the second spacer 202, the wall 232 of the second spacer wall 230B is opposed to the first energy storage device 101 in the X-axis direction. The same applies to the third spacer 203.

The wall 232 and the walls 222 and 223 are positioned at different positions in the X-axis direction, and at least a portion thereof is positioned at the same position in the Z-axis direction. Specifically, the wall 232 is positioned in the X-axis positive direction relative to the wall 222, and an end of the wall 232 in the Z-axis positive direction is positioned at the same position in the Z-axis direction as an end of the wall 222 in the Z-axis negative direction. The wall 232 is positioned in the X-axis negative direction relative to the wall 223, and an end of the wall 232 in the Z-axis negative direction is positioned at the same position in the Z-axis direction as an end of the wall 223 in the Z-axis positive direction. Accordingly, the wall 232 of the first spacer wall 230A is positioned in the X-axis positive direction of the wall 222 of the third spacer wall 220C and in the X-axis negative direction of the wall 223 of the third spacer wall 220C, and at least a portion thereof overlaps the walls 222 and 223 in the X-axis direction. The same applies to the wall 232 of the second spacer wall 230B and the walls 222 and 223 of the first spacer wall 220A.

The wall 233 is a plate-shaped wall parallel to the YZ plane, protruding in the Y-axis negative direction from a position, at an end of the spacer main body 210 in the X-axis positive direction, that is in the Z-axis negative direction relative to the wall 223 and in the Z-axis positive direction relative to the wall 224. The wall 233 is opposed to the energy storage device 100 positioned in the Y-axis negative direction of the spacer main body 210 and the case wall 311, in the X-axis direction. In the first spacer 201, the wall 233 of the first spacer wall 230A is opposed to the second energy storage device 102 in the X-axis direction, and in the second spacer 202, the wall 233 of the second spacer wall 230B is opposed to the first energy storage device 101 in the X-axis direction. The same applies to the third spacer 203.

The wall 233 and the walls 223 and 224 are positioned at different positions in the X-axis direction, and at least a portion thereof is positioned at the same position in the Z-axis direction. Specifically, the wall 233 is positioned in the X-axis negative direction relative to the wall 223, and an end of the wall 233 in the Z-axis positive direction is positioned at the same position in the Z-axis direction as an end of the wall 223 in the Z-axis negative direction. The wall 233 is positioned in the X-axis positive direction relative to the wall 224, and an end of the wall 233 in the Z-axis negative direction is positioned at the same position in the Z-axis direction as an end of the wall 224 in the Z-axis positive direction. Accordingly, the wall 233 of the first spacer wall 230A is positioned in the X-axis negative direction of the wall 223 of the third spacer wall 220C and in the X-axis positive direction of the wall 224 of the third spacer wall 220C, and at least a portion thereof overlaps the walls 223 and 224 in the X-axis direction. The same applies to the wall 233 of the second spacer wall 230B and the walls 223 and 224 of the first spacer wall 220A.

The wall 223 is longer in the Z-axis direction than the walls 232 and 233. In the present example embodiment, the walls 222 and 224 have lengths equal to those of the walls 232 and 233 in the Z-axis direction. However, the walls 222 and 224 may be longer than those of the walls 232 and 233. The walls 232 and 233 have the same length in the Z-axis direction. However, the walls 232 and 233 may have different lengths in the Z-axis direction. The lengths of the walls 221, 225, 231, and 234 in the Z-axis direction are not particularly limited.

The wall 223 is positioned in the Z-axis negative direction relative to the walls 221 and 222, and is positioned in the Z-axis positive direction relative to the walls 224 and 225. Accordingly, the wall 223 is positioned closer to the center position of the energy storage device 100 in the Z-axis direction than the walls 221, 222, 224, and 225 are. The wall 223 is closer to the terminal 140 of the energy storage device 100 than the walls 224 and 225 are. The walls 221 and 222 are closer to the terminal 140 of the energy storage device 100 than the walls 223 to 225 are.

When viewed in the X-axis direction, the walls 222 to 224 are positioned at positions at which edges thereof in the Y-axis positive direction overlap the energy storage devices 100 positioned in the Y-axis positive direction of the spacer main body 210. That is, the walls 222 to 224 are positioned so as not to protrude in the Y-axis positive direction from a surface (the long side surface 111) of the energy storage device 100 in the Y-axis positive direction. To be more specific, the lengths of the walls 222 to 224 in the Y-axis direction are shorter than the thickness of the energy storage device 100 in the Y-axis direction (the widths of the short side surfaces 112 in the Y-axis direction). The lengths of the walls 221 and 225 in the Y-axis direction are not particularly limited. Similarly, when viewed in the X-axis direction, the walls 232 and 233 are positioned at positions at which edges thereof in the Y-axis negative direction overlap the energy storage devices 100 positioned in the Y-axis negative direction of the spacer main body 210. That is, the walls 232 and 233 are positioned so as not to protrude in the Y-axis negative direction from a surface (the long side surface 111) of the energy storage device 100 in the Y-axis negative direction. To be more specific, the lengths of the walls 232 and 233 in the Y-axis direction are shorter than the thickness of the energy storage device 100 in the Y-axis direction (the widths of the short side surfaces 112 in the Y-axis direction). The lengths of the walls 231 and 234 in the Y-axis direction are not particularly limited.

The wall 221 includes a convex portion 221a protruding toward the case wall 311. The convex portion 221a is a convex portion (rib) having a substantially cylindrical shape and protruding in the X-axis positive direction, and has a truncated conical shape in which an end (base) in the X-axis negative direction has a larger diameter toward the X-axis negative direction, for ensuring strength, and the like. The convex portion 221a is positioned at an end of the wall 221 in the Y-axis negative direction and at a central portion thereof in the Z-axis direction. The convex portion 221a is not overlapping the spacer main body 210 when viewed in the X-axis direction. The convex portion 221a is separated (with a gap) from the case wall 311.

The wall 223 includes a convex portion 223a protruding toward the case wall 311. The convex portion 223a is a convex portion (rib) having a substantially rectangular parallelepiped shape protruding in the X-axis positive direction, and has a truncated quadrangular pyramid shape in which an end (base) in the X-axis negative direction has a larger diameter toward the X-axis negative direction, to ensure strength, and the like. The convex portion 223a is positioned at an end of the wall 223 in the Y-axis positive direction and at a central portion thereof in the Z-axis direction. The convex portion 223a is not overlapping the spacer main body 210 when viewed in the X-axis direction. The convex portion 223a is separated (with a gap) from the case wall 311.

The wall 225 includes a convex portion 225a protruding toward the case wall 311. The convex portion 225a is a convex portion (rib) having a substantially rectangular parallelepiped shape protruding in the X-axis positive direction, and has a truncated quadrangular pyramid shape in which an end (base) in the X-axis negative direction has a larger diameter toward the X-axis negative direction, to ensure strength, and the like. The convex portion 225a is positioned at an end of the wall 225 in the Y-axis positive direction and an end thereof in the Z-axis negative direction. The convex portion 225a is not overlapping the spacer main body 210 when viewed in the X-axis direction. The convex portion 225a is separated (with a gap) from the case wall 311.

The convex portion 223a is smaller in size than the convex portion 225a when viewed in the X-axis direction. To be specific, the convex portion 223a has an area when viewed in the X-axis direction (or a minimum cross-sectional area in the YZ plane) which is smaller than that of the convex portion 225a. The convex portion 221a is smaller in size than the convex portions 223a and 225a when viewed in the X-axis direction. To be specific, the convex portion 221a has an area when viewed in the X-axis direction (or a minimum cross-sectional area in the YZ plane) which is smaller than the convex portion 223a and the convex portion 225a.

The tip end of the convex portion 223a is positioned in the X-axis positive direction relative to the tip end of the convex portion 225a (refer to FIGS. 4A, 4B, 5A and 5B). That is, the convex portion 223a protrudes in the X-axis positive direction relative to the convex portion 225a. In the present example embodiment, the protruding amount of the convex portion 223a is substantially the same level as the protruding amount of the convex portion 225a or smaller than the protruding amount of the convex portion 225a. However, since the wall 223 is positioned in the X-axis positive direction relative to the wall 225, the tip end of the convex portion 223a is positioned in the X-axis positive direction relative to the tip end of the convex portion 225a. The protruding amount of the convex portion 223a may be larger than the protruding amount of the convex portion 225a. The tip end of the convex portion 221a is positioned in the X-axis positive direction relative to the tip ends of the convex portions 223a and 225a (refer to FIGS. 4A, 4B, 5A and 5B). That is, the convex portion 221a protrudes further in the X-axis positive direction than the convex portions 223a and 225a. In the present example embodiment, since the wall 221 is positioned in a position substantially the same level as that of the wall 225 in the X-axis direction, the protruding amount of the convex portion 221a is larger than the protruding amount of the convex portion 225a. Since the wall 221 is positioned in the X-axis negative direction relative to the wall 223, the protruding amount of the convex portion 221a is larger than the protruding amount of the convex portion 223a.

The wall 222 includes a reinforcing rib 222a inside a position (base) to be bent from the spacer main body 210 (refer to FIGS. 5A and 5B). The wall 223 includes a reinforcing rib 223b inside a position (base) to be bent from the spacer main body 210 (refer to FIGS. 5A and 5B). The wall 224 includes a reinforcing rib 224a inside a position (base) to be bent from the spacer main body 210 (refer to FIGS. 5A and 5B). The wall 231 includes a reinforcing rib 231a inside a position (base) bent from the spacer main body 210 (refer to FIGS. 4A and 4B). The wall 234 includes a reinforcing rib 234a inside a position (base) to be bent from the spacer main body 210 (refer to FIGS. 4A and 4B).

That is, the reinforcing ribs 222a, 224a, 231a, and 234a are provided on the walls 222, 224, 231, and 234 to hold the energy storage devices 100. In addition, a reinforcing rib 223b is provided on the wall 223 including the convex portion 223a. Because the walls 221 and 225, including the convex portions 221a and 225a, are coupled to the walls 222 and 224, no reinforcing rib is provided on the walls 221 and 225. However, the walls 221 and 225 may also be provided with reinforcing rib(s). The walls 232 and 233 may also be provided with reinforcing rib(s).

The walls 222 to 224 protrude only in the Y-axis positive direction in the Y-axis direction. Therefore, as illustrated in FIG. 7 and FIG. 8, openings 21, 23, and 25 are provided in the Y-axis negative direction of the walls 222 to 224. The openings 21, 23, and 25 are positioned at a boundary between an internal space and an external space of the energy storage assembly 10, and are provided in the energy storage assembly 10 when viewed in the X-axis direction, in order to communicate the internal space with the external space of the energy storage assembly 10. The openings 21, 23, and 25 are between the spacer main body 210 and the energy storage device 100 positioned in the Y-axis negative direction of the spacer main body 210, by separating a portion of a surface of the spacer main body 210 in the Y-axis negative direction and a portion of the energy storage device 100. The openings 21, 23, and 25 are positioned at different positions in the Z-axis direction.

To be specific, the opening 21 which connects the space 211a (refer to FIGS. 4A and 4B) with an external space S (refer to FIG. 7), which is a space outside the energy storage assembly 10, is provided in the Y-axis negative direction of the wall 222. The external space S is a space positioned in the X-axis positive direction of the energy storage assembly 10 (the energy storage devices 100 and the spacer 200a). An opening 23 which connects the space 211b (refer to FIGS. 4A and 4B) with the external space S of the energy storage assembly 10 is provided in the Y-axis negative direction of the wall 223. An opening 25 which connects the space 211d (refer to FIGS. 4A and 4B) with the external space S of the energy storage assembly 10 is provided in the Y-axis negative direction of the wall 224. The wall 222 protrudes in the Y-axis positive direction from the position of the opening 21 in the spacer main body 210. The wall 223 protrudes in the Y-axis positive direction from the position of the opening 23 in the spacer main body 210. The wall 224 protrudes in the Y-axis positive direction from the position of the opening 25 in the spacer main body 210. As described above, the spaces 211a to 211d are each a flow path for a fluid that flows between the spacer main body 210 and the energy storage device 100, and the openings 21, 23, and 25 are outlets of the flow path. Therefore, the energy storage assembly 10 includes, in addition to the openings 21, 23, and 25 defining the outlets of the flow paths, an opening defining an inlet of the flow path at an end in the Z-axis negative direction (refer to FIGS. 4A and 4B).

The walls 232 and 233 protrude only in the Y-axis negative direction in the Y-axis direction. Therefore, as illustrated in FIG. 7 and FIG. 8, openings 22 and 24 are provided in the Y-axis positive direction of the walls 232 and 233. The openings 22 and 24 are openings which are positioned at a boundary between an internal space and an external space of the energy storage assembly 10 and are provided in the energy storage assembly 10 when viewed in the X-axis direction, in order to connect the internal space and the external space of the energy storage assembly 10. The openings 22 and 24 are provided by separating a portion of a surface of the spacer main body 210 in the Y-axis positive direction and a portion of the energy storage device 100, between the spacer main body 210 and the energy storage device 100 positioned in the Y-axis positive direction of the spacer main body 210. The openings 22 and 24 are positioned at different positions in the Z-axis direction. The openings 22 and 24 are positioned at positions different from the openings 21, 23, and 25 in the Z-axis direction.

To be specific, the opening 22 coupling the space 215a (refer to FIGS. 5A and 5B) to the external space S, which is a space outside the energy storage assembly 10, is provided in the Y-axis positive direction of the wall 232. An opening 24 which connects the space 215a (refer to FIGS. 5A and 5B) with an external space S, which is a space outside the energy storage assembly 10, is provided in the Y-axis positive direction of the wall 233. The wall 232 protrudes in the Y-axis negative direction from the position of the opening 22 in the spacer main body 210. The wall 233 protrudes in the Y-axis negative direction from the position of the opening 24 in the spacer main body 210.

In the above-described configuration, the wall 223 of the first spacer wall 220A of the first spacer 201 is an example of a first wall. That is, the wall 223 (first wall) is a wall protruding from the spacer main body 210 in the Y-axis positive direction or the Y-axis negative direction (one side or an other side in the first direction), and opposed to the case wall 311 in the X-axis direction (second direction). In the present example embodiment, the wall 223 (first wall) protrudes from the spacer main body 210 only in the Y-axis positive direction (to the one side in the first direction) in the Y-axis direction (first direction). The wall 223 (first wall) protrudes from the spacer main body 210 in the Y-axis positive direction (the one side in the first direction) without protruding in the Y-axis negative direction (the other side in the first direction), and is opposed to the first energy storage device 101 in the X-axis direction (a second direction intersecting the first direction). The wall 223 (first wall) is positioned such that an edge thereof in the Y-axis positive direction (the one side in the first direction) overlaps the first energy storage device 101 when viewed in the X-axis direction (second direction).

The wall 232 on the first spacer wall 230A of the first spacer 201 is an example of a second wall. That is, the wall 232 (second wall) protrudes from the spacer main body 210 in the Y-axis negative direction (the other side in the first direction), and is opposed to the second energy storage device 102 in the X-axis direction (second direction). The wall 232 (second wall) is positioned in the Z-axis positive direction (one side in the third direction intersecting the first direction and the second direction) relative to the wall 223 (first wall). The wall 223 (first wall) and the wall 232 (second wall) are positioned in different positions in the X-axis direction (second direction). In the Z-axis direction (third direction), the wall 223 (first wall) and the wall 232 (second wall) are positioned at least partially at the same position. The wall 223 (first wall) is longer in the Z-axis direction (third direction) than the wall 232 (second wall).

The wall 222 of the first spacer wall 220A of the first spacer 201 is an example of the third wall. That is, the wall 222 (third wall) is positioned in the Z-axis positive direction (one side in the third direction) relative to the wall 232 (second wall), protrudes in the Y-axis positive direction (one side in the first direction) from the spacer main body 210, and is opposed to the first energy storage device 101 in the X-axis direction (second direction).

The space 211b and the opening 23 defined by the first spacer 201 are an example of a first space and a first opening, respectively. The space 211a and the opening 21 defined by the first spacer 201 are an example of a second space and a second opening, respectively. That is, the energy storage assembly 10 includes an opening 23 (first opening) which connects the space 211b (first space) between the spacer main body 210 and the second energy storage device 102 with an external space S, which is an outside space, of the energy storage assembly 10, in the Y-axis negative direction (other side in the first direction) of the wall 223 (first wall). The energy storage assembly 10 further includes an opening 21 (second opening) which connects the space 211a (second space) between the spacer main body 210 and the second energy storage device 102 with the external space S, in the Y-axis negative direction (the other side in the first direction) of the wall 222 (third wall).

As described above, according to the energy storage apparatus 1 of the present example embodiment, the spacer 200a includes a wall 223 (first wall) opposed to the first energy storage device 101 in the X-axis direction (second direction), and a wall 232 (second wall) opposed to the second energy storage device 102 in the X-axis direction (second direction). Accordingly, the wall 223 (first wall) of the spacer 200a ensures insulation of the first energy storage device 101 in the X-axis direction (second direction) (high-voltage protection and improvement in insulative properties). The wall 232 (second wall) of the spacer 200a ensures insulation of the second energy storage device 102 in the X-axis direction (second direction) (high-voltage protection and improvement in insulative properties). The energy storage assembly 10 includes, in the Y-axis negative direction (the other side in the first direction) of the wall 223 (first wall), an opening 23 (first opening) which connects a space 211b (first space) between the spacer main body 210 and the second energy storage device 102 with an external space S of the energy storage assembly 10. Accordingly, the opening 23 (first opening) secures a flow path for a fluid (a refrigerant such as air) that flows through a space 211b (first space, an internal space of the energy storage assembly 10) between the spacer main body 210 and the second energy storage device 102, and the external space S of the energy storage assembly 10. Therefore, it is possible to improve the insulative properties while cooling the energy storage device 100. Since the spacer 200a includes the wall 223 (first wall) and the wall 232 (second wall), it is also possible to improve vibration resistance and shock resistance of the first energy storage device 101 and the second energy storage device 102 in the X-axis direction (second direction).

In particular, the energy storage apparatus 1 includes a non-restraint type energy storage assembly 10 which does not include any restraint (such as end plate and side plate) to restrain the plurality of energy storage devices 100 and the spacers 200. Therefore, when vibration, shock, or the like, is applied to the energy storage apparatus 1 from outside, the energy storage devices 100 and the spacers 200 easily move within the case 300, and the energy storage devices 100 and the spacers 200 easily approach the case wall 311. Even when the spacers 200 are separated from the case wall 311 (with a gap therebetween), the spacers 200 easily move and easily come into contact with the case wall 311. Therefore, the effect of improving the insulative properties of the energy storage device 100 is high.

The wall 223 (first wall) and the wall 232 (second wall) of the spacer 200a are positioned at different positions in the X-axis direction (second direction). Accordingly, during assembly of the energy storage assembly 10, or the like, it is possible to restrain the wall 223 (first wall) of one spacer 200a, of the two spacers 200a sandwiching the energy storage device 100, and the wall 232 (second wall) of the other spacer 200a from coming into contact with each other.

The wall 223 (first wall) and the wall 232 (second wall) of the spacer 200a are positioned at least partially at the same position in the Z-axis direction (third direction). Accordingly, the wall 223 (first wall) of one spacer 200a, of the two spacers 200a sandwiching an energy storage device 100, and the wall 232 (second wall) of the other spacer 200a are overlapped. Therefore, improved insulative properties (high-voltage protection and improvement in insulative properties) of the energy storage device 100 in the X-axis direction (second direction) are further achieved. It is also possible to further improve vibration resistance and shock resistance of the energy storage device 100 in the X-axis direction (second direction).

By increasing the length of the wall 223 (first wall) of the spacer 200a in the Z-axis direction (third direction), the length of the opening 23 (first opening) in the Z-axis direction (third direction), which is positioned in the Y-axis negative direction (the other side in the first direction) of the wall 223 (first wall), is increased. Accordingly, a flow path for a fluid (a refrigerant such as air) that flows between the space 211b (first space) and the external space S is secured to be relatively large.

The spacer 200a further includes a wall 222 (third wall) opposed to the first energy storage device 101 in the X-axis direction (second direction). Accordingly, the first energy storage device 101 is further insulated (high-voltage protection and improvement in insulative properties can be achieved) in the X-axis direction (second direction) by the wall 222 (third wall) of the spacer 200a. The energy storage assembly 10 further includes, in the Y-axis negative direction (the other side in the first direction) of the wall 222 (third wall), an opening 21 (second opening) which connects a space 211a (second space) between the spacer main body 210 and the second energy storage device 102 with an external space S of the energy storage assembly 10. Accordingly, the opening 21 (second opening) secures a flow path for a fluid (a refrigerant such as air) that flows through a space 211a (second space, an internal space of the energy storage assembly 10) between the spacer main body 210 and the second energy storage device 102, and the external space S of the energy storage assembly 10. Since the spacer 200a further includes the wall 222 (third wall), vibration resistance and shock resistance of the first energy storage device 101 in the X-axis direction (second direction) is also further improved.

An edge (tip end) of the wall 223 (first wall) of the spacer 200a in the Y-axis positive direction (one side in the first direction) overlaps the first energy storage device 101 when viewed in the X-axis direction (second direction), such that the wall 223 (first wall) does not protrude from the first energy storage device 101. Therefore, it is possible to restrain the wall 223 (first wall) from closing a flow path for a fluid (refrigerant such as air) in the Y-axis positive direction (one side in the first direction) of the first energy storage device 101.

Since the spacer 200a includes the wall 223 (first wall) opposed to the case wall 311 in the X-axis direction (second direction), the insulative properties between the energy storage device 100 and the case wall 311 are improved by the wall 223 (first wall). However, when the wall 223 (first wall) is in surface contact with the case wall 311, a creepage distance between the energy storage device 100 and the case wall 311 is reduced. Therefore, by providing the wall 223 (first wall) with a convex portion 223a protruding toward the case wall 311, the wall 223 (first wall) is restrained from being in surface contact with the case wall 311. Accordingly, since the creepage distance between the energy storage device 100 and the case wall 311 can be increased, the insulative properties between the energy storage device 100 and the case wall 311 are further improved. In particular, the energy storage assembly 10 is a non-restraint type, and thus the spacers 200 easily move and easily come into contact with the case wall 311. Therefore, the effect of being able to increase the creepage distance between the energy storage devices 100 and the case wall 311 is high.

When the spacer 200a does not include the wall 223 (first wall), it is necessary to position the convex portion 223a to overlap the spacer main body 210 when viewed in the X-axis direction (second direction), and therefore, a region in which the convex portion 223a can be positioned is narrow, and it is difficult to position the convex portion 223a. In contrast, since the convex portion 223a is positioned on the wall 223 (first wall), the convex portion 223a can be positioned to not overlap the spacer main body 210 when viewed in the X-axis direction (second direction). Therefore, the convex portion 223a can be easily positioned on the spacer 200a.

In the spacer 200a, even in a configuration in which the wall 223 (first wall) protrudes from the spacer main body 210 only in the Y-axis positive direction (to one side in the first direction), as long as the wall 223 (first wall) is provided, the convex portion 223a can be positioned on the wall 223 (first wall). Therefore, the convex portion 223a can be easily positioned on the spacer 200a.

The spacer 200a further includes a wall 225 opposed to the case wall 311 in the X-axis direction (second direction), in a position different from that of the wall 223 (first wall) in the Z-axis direction (third direction). Accordingly, even in a position different from that of the wall 223 (first wall) in the Z-axis direction (third direction), the insulative properties between the energy storage device 100 and the case wall 311 are improved by the wall 225.

Since the wall 223 (first wall) provided with the convex portion 223a is closer to the center position of the energy storage device 100 than the wall 225, the creepage distance between the energy storage device 100 and the case wall 311 can be increased in a well-balanced manner by the convex portion 223a. Since the wall 223 (first wall) is close to the center position of the energy storage device 100, it is possible to restrain the energy storage assembly 10 from being inclined when the convex portion 223a is brought into contact with the case wall 311, and therefore, it is possible to restrain an occurrence of deviation in distances between the energy storage assembly 10 and the case wall 311. Accordingly, the creepage distance between the energy storage devices 100 and the case wall 311 can be increased in a well-balanced manner.

Since the convex portion 225a is provided on the wall 225 of the spacer 200a, it is possible to restrain both the wall 223 (first wall) and the wall 225 from being in surface contact with the case wall 311. Accordingly, the creepage distance between the energy storage device 100 and the case wall 311 can be further increased.

In the energy storage device 100, since various structural elements, such as a bus bar, a sensor, a substrate, and wiring, are positioned close to the terminals 140, it is difficult to completely cover the energy storage device 100 with the spacer 200a, and there is a concern that insulative properties may deteriorate. On the other hand, as the size of the convex portion provided on the wall of the spacer 200a (the size when viewed from the X-axis direction (second direction)) is smaller, the creepage distance between the energy storage device 100 and the case wall 311 is larger. Therefore, the wall 223 (first wall) is positioned closer to the terminals 140 of the energy storage devices 100 than the wall 225, and the size of the convex portion 223a provided on the wall 223 (first wall) is made smaller than that of the convex portion 225a when viewed in the X-axis direction (second direction). Accordingly, it is possible to increase a creepage distance between the energy storage device 100 and the case wall 311 in a position close to the terminal 140 of the energy storage device 100, at which there is a concern that insulative properties may deteriorate.

In the energy storage apparatus 1, various structural elements such as a bus bar, a sensor, a substrate, and wiring are positioned close to the opening 310a of the case main body 310, it is difficult to completely cover the energy storage device 100 with the spacer 200a, and there is a concern that insulative properties may deteriorate. On the other hand, when the convex portion provided on the wall of the spacer 200a protrudes, the creepage distance between the energy storage device 100 and the case wall 311 increases. Therefore, the wall 223 (first wall) is positioned in the Z-axis positive direction (one side in the third direction) relative to the wall 225, and the tip end of the convex portion 223a provided on the wall 223 (first wall) is positioned in the X-axis positive direction (one side in the second direction) relative to the tip end of the convex portion 225a. That is, the wall 223 (first wall) is positioned closer to the opening 310a of the case main body 310 than the wall 225, and the convex portion 223a protrudes beyond the convex portion 225a. Accordingly, a creepage distance between the energy storage device 100 and the case wall 311 can be increased in a position close to the opening 310a of the case main body 310, at which there is a concern that insulative properties may deteriorate.

Since the convex portion 223a close to the opening 310a of the case main body 310 protrudes beyond the convex portion 225a, it is easy to insert the energy storage assembly 10 into the case main body 310. In particular, when the case wall 311 is inclined by an angle, or the like, since the convex portion 223a protrudes beyond the convex portion 225a, the energy storage assembly 10 can be easily inserted into the case main body 310, and the tip ends of the convex portion 223a and the convex portion 225a can be positioned along the case wall 311.

The spacer main body 210 of the spacer 200a includes a second surface 215 in a position of the first surface 214 facing the first energy storage device 101, the position being recessed relative to the first surface 214 in the X-axis direction (second direction). The energy storage assembly 10 includes an opening 22 which connects a space 215a between the second surface 215 and the first energy storage device 101 with an external space S of the energy storage assembly 10. As described above, since the spacer main body 210 includes, in addition to the first surface 214 facing the first energy storage device 101, the second surface 215 in a position of the first surface 214, which is recessed relative to the first surface 214 in the X-axis direction (second direction), the space 215a can be defined by the second surface 215 while swelling of the first energy storage device 101 is restrained by the first surface 214. Since the energy storage assembly 10 includes the opening 22 which connects the space 215a (the internal space of the energy storage assembly 10) with the external space S of the energy storage assembly 10, the first energy storage device 101 can be held by inserting a jig into the space 215a from the opening 22, and therefore, workability during manufacturing is improved. Further, since the spacer 200a includes the wall 223 (first wall) facing the first energy storage device 101 in the X-axis direction (second direction), insulation of first energy storage device 101 in the X-axis direction (second direction) (high-voltage protection and improvement in insulative properties) is ensured using the wall 223 (first wall). In particular, as described above, since the energy storage assembly 10 is of a non-constrained type, the energy storage devices 100 and the spacers 200 easily approach the case wall 311. Therefore, the effect of improving the insulative properties of the energy storage device 100 is high. Since the spacer 200a includes the wall 223 (first wall), vibration resistance and shock resistance of the first energy storage device 101 in the X-axis direction (second direction) is also improved. Accordingly, in the energy storage apparatus 1, it is possible to ensure maintenance of the performance while improving the workability during manufacturing.

In the spacer 200a, since the first surface 214 is larger than the second surface 215, even when the spacer main body 210 is recessed to provide the second surface 215 that defines the space 215a, swelling of the first energy storage device 101 can be effectively restrained by the first surface 214.

In the spacer 200a, the spacer main body 210 includes the third surface 216 in a position recessed relative to the first surface 214, and the second surface 215 is recessed relative to the third surface 216. Accordingly, the first surface 214 protrudes from the third surface 216, and the second surface 215 is recessed from the third surface 216. Therefore, since the first surface 214 which reduces or prevents swelling of the first energy storage device 101 can be positioned to protrude from the third surface 216, and the second surface 215 which defines the space 215a can be positioned to be recessed from the third surface 216, the first surface 214 and the second surface 215 can be configured in desired shapes at desired positions.

An edge (tip end) of the wall 223 (first wall) of the spacer 200a in the Y-axis positive direction (one side in the first direction) overlaps the first energy storage device 101 when viewed in the X-axis direction (second direction), such that the wall 223 (first wall) does not protrude from the first energy storage device 101. Therefore, it is possible to restrain the wall 223 (first wall) from becoming an obstacle when a jig is inserted in the Y-axis positive direction (one side in the first direction) of the first energy storage device 101.

The energy storage assembly 10 includes an opening 23 which connects a space 211b (an internal space of the energy storage assembly 10) between the spacer main body 210 of the spacer 200a and the second energy storage device 102 with an external space S of the energy storage assembly 10. The space 211b is a flow path for a fluid that flows between the spacer main body 210 and the second energy storage device 102. Accordingly, by using, as the space 211b, a flow path for a fluid (a refrigerant such as air) that flows between the spacer main body 210 and the second energy storage device 102, a jig can be inserted into the flow path (the space 211b) from the opening 23, and therefore the second energy storage device 102 can be held with a simple configuration.

Although the effect of a portion of the walls included in the spacer 200a has been described above, the same effect is achieved with the other walls. Further, although the effect of a portion of the spacers 200a included in the energy storage assembly 10 has been described, the same effect is achieved with the other spacers 200a.

Thus far, an energy storage apparatus 1 according to an example embodiment of the present invention has been described. However, the present invention is not limited to the above-described example embodiment. All of the example embodiments disclosed herein are illustrative, and the scope of the present invention includes all modifications within the meaning and scope of equivalence with the scope of claims.

In the above-described example embodiment, the spacer walls 220 and 230 (the walls 221 to 225, and 231 to 234) of the spacer 200a are opposed to the short side surface 112 of the container 110 of the energy storage device 100. However, the spacer walls 220 and 230 (the walls 221 to 225, and 231 to 234) of the spacer 200a may be opposed to the bottom surface 113 or the container lid portion 130 of the container 110. The case wall 311, to which the spacer walls 220 and 230 (the walls 221 to 225, and 231 to 234) oppose, is a side wall of the case main body 310. However, the case wall 311 may be a bottom wall of the case main body 310, or may be a side wall, an upper wall, or the like, of the lid 320.

In the above-described example embodiment, the wall 223 of the spacer 200a is an example of the first wall, the wall 232 is an example of the second wall, and the wall 222 is an example of the third wall. However, the present invention is not limited thereto. The wall 223 may be an example of the first wall, the wall 233 may be an example of the second wall, and the wall 224 may be an example of the third wall. The wall 223 may be an example of the first wall and the wall 231 or 234 may be an example of the second wall. The wall 222 may be an example of the first wall and any of the wall 231 to 234 may be an example of the second wall; or the wall 224 may be an example of the first wall, and any of the wall 231 to 234 may be an example of the second wall.

In the above-described example embodiment, the positions of the walls 221 to 225 and 231 to 234 of the spacer 200a in the X-axis direction and the Z-axis direction are not limited to the above, and can be positioned at various positions. The lengths of the walls 221 to 225 and 231 to 234 in the Y-axis direction and the Z-axis direction are also not limited to the above, and can be configured to have various lengths. Any of the walls 221 to 225 and 231 to 234 does not necessarily have to be provided, or any wall other than the walls 221 to 225 and 231 to 234 may be provided. Additionally, the sizes, shapes, positioned positions, numbers, and the like, of the spaces 211a to 211d, and 215a, and the openings 21 to 25 are not limited to those described above.

In the above-described example embodiment, the convex portions 221a, 223a, and 225a are provided on the walls 221, 223, and 225 of the spacer 200a. However, it is not always necessary to provide any convex portion on any of the walls 221, 223, and 225. A convex portion may be provided on any of the walls 222, 224, and 231 to 234. The positioned position, shape, size of the convex portion provided on the wall are not limited to those described above. From the viewpoint of ensuring strength, or the like, the convex portion may elongate in the Y-axis direction, the Z-axis direction, or a direction inclined from these directions, over a portion (half, or the like) or all of the wall, in these directions.

In the above-described example embodiment, in the spacer 200a, the tip end of the convex portion 223a protrudes beyond the tip end of the convex portion 225a, and the tip end of the convex portion 221a protrudes beyond the tip end of the convex portion 223a. However, the present invention is not limited thereto. The tip end of the convex portion 225a may protrude beyond the tip end of the convex portion 223a, and the tip end of the convex portion 223a may protrude beyond the tip end of the convex portion 221a, and the tip end positions of these convex portions are not particularly limited, and are appropriately determined according to the shape of the case 300, or the like. When the convex portion 221a is opposed to the wall of the lid 320, the tip end position of the convex portion 221a is determined according to the position of the wall of the lid 320, and the tip end of the convex portion 221a does not necessarily have to be set to protrude beyond the tip end of the side wall of the convex portion 223a.

In the above-described example embodiment, the wall 223 of the spacer 200a protrudes only in the Y-axis positive direction. However, the wall 223 of the spacer 200a may protrude only in the Y-axis negative direction, or may protrude in both the Y-axis positive direction and the Y-axis negative direction. When the wall 223 protrudes in both the Y-axis positive direction and the Y-axis negative direction, a through hole as the opening 23 may be provided in the wall 223. However, it is preferable that the wall 223 protrudes only in the Y-axis positive direction, because no through hole is needed in the wall 223, and thus the spacer 200a can be easily manufactured (the mold structure can be simplified). The same applies to the other walls.

In the above-described example embodiment, the spaces 211a to 211d in the spacer main body 210 of the spacer 200a are partitioned from each other by the ribs. However, the present invention is not limited thereto. Any spaces among the spaces 211a to 211d may be connected to each other without being partitioned by ribs, such as the space 211a and the space 211b being connected to each other without being partitioned by ribs.

In the above-described example embodiment, the spacer main body 210 of the spacer 200a includes the third surface 216 in a position recessed relative to the first surface 214, and the second surface 215 is positioned in a position recessed relative to the third surface 216. However, the present invention is not limited thereto. As long as the second surface 215 is recessed relative to the first surface 214, the second surface 215 may protrude from the third surface 216, or the first surface 214 may be recessed relative to the third surface 216. The spacer main body 210 does not necessarily include the third surface 216, and the second surface 215 may be recessed from the first surface 214. The first surface 214 has been described to be larger than the second surface 215 and the third surface 216. However, the first surface 214 may be smaller than either the second surface 215 or the third surface 216.

In the above-described example embodiment, on the surface of the spacer main body 210 of the spacer 200a in the Y-axis positive direction, the space 215a is not a flow path for a fluid that flows between the spacer main body 210 and the energy storage device 100. However, the space 215a may be a flow path. That is, also on the surface of the spacer main body 210 in the Y-axis positive direction, a space (flow path) such as the space 211a to 211d may be provided at the position of the space 215a, similarly to the surface of the spacer main body 210 in the Y-axis negative direction. According to this configuration, since a flow path through which a fluid (refrigerant) flows can be provided on both surfaces of the spacer main body 210 in the Y-axis direction, two energy storage devices 100 positioned on both sides of the spacer 200a in the Y-axis direction are cooled. Further, both surfaces of the energy storage device 100 in the Y-axis direction are cooled by the two spacer 200a sandwiching one energy storage device 100. Accordingly, the cooling efficiency of the energy storage device 100 is improved.

In the above-described example embodiment, the spacer 200a includes the spacer walls 220 to 250. However, the spacer 200a does not necessarily have to include one of these spacer walls. In this case, the spacer 200a does not have to be a holder that holds the energy storage device 100.

In the above-described example embodiment, all of the spacers 200a have the above-described configuration. However, any of the spacers 200a does not necessarily have the above-described configuration.

In the above-described example embodiment, the spacer 200b or the spacer 200c may have a configuration similar to that of the spacer 200a. That is, any spacer 200 among the plurality of spacers 200 may have the above-described configuration similar to that of the spacer 200a.

In the above-described example embodiment, the spacers 200 (the spacers 200a, 200b, and 200c) are alternately positioned with the energy storage devices 100 in the Y-axis direction. However, a configuration in which any of the spacers 200 is not positioned may be used. A configuration in which only one spacer 200 (spacer 200a, 200b, or 200c) is positioned may be used.

In the above-described example embodiment, the case 300 is made of metal. However, the case 300 may be made of a material with insulative properties, such as any resin material that can be adopted for the spacer 200. Even in this case, since various structures made of metal may be positioned in the case 300, it is important to improve the insulative properties of the energy storage device 100.

In the above-described example embodiment, the case main body 310 has a sufficient height in the Z-axis direction to accommodate therein the energy storage assembly 10, and is assembly 10 is hardly configured such that the energy storage exposed when viewed from the XY plane. However, this is not essential. The case main body 310 may have a height of about two thirds or about a half of the energy storage assembly 10 in the Z-axis direction, accommodate therein a portion of the energy storage assembly 10 in the Z-axis negative direction, and expose a portion of the energy storage assembly 10 in the Z-axis positive direction without accommodating therein the portion. In this case, the lid 320 may have a height of about one third or about a half of the energy storage assembly 10 in the Z-axis direction, and accommodate a portion of the energy storage assembly 10 in the Z-axis positive direction. In this case, as described above, the convex portion 221a of the wall 221 of the spacer 200a may be opposed to the wall of the lid 320.

In the above-described example embodiment, the case 300 includes the case main body 310 and the lid 320. However, the case 300 does not necessarily include the lid 320. In the above-described example embodiment, two energy storage assemblies 10 positioning in the X-axis direction are accommodated inside the case 300. However, three or more energy storage assemblies 10 positioning in the X-axis direction may be accommodated inside the case 300, or only one energy storage assembly 10 may be accommodated inside the case 300. A plurality of energy storage assemblies 10 positioned in the Y-axis direction may be accommodated inside the case 300. In the above-described example embodiment, the energy storage assembly 10 may include a restraint (end plate, side plate, or the like) that restrains the plurality of energy storage devices 100 and the spacers 200, or the like.

Additional example embodiments including combinations and modifications of elements, features, characteristics, etc., included in the above-described example embodiments and the modification examples thereof are also included in the scope of the present invention.

Example embodiments of present invention can be applied to energy storage apparatuses, etc., each including an energy storage device such as a lithium-ion secondary battery.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
an energy storage assembly including:
a spacer including a spacer main body;
a first energy storage device positioned on one side in a first direction of the spacer main body; and
a second energy storage device positioned on an other side in the first direction of the spacer main body; wherein
the spacer includes:
a first wall opposed to the first energy storage device in a second direction intersecting the first direction, the first wall protruding on the one side in the first direction from the spacer main body; and
a second wall opposed to the second energy storage device in the second direction, the second wall protruding on the other side in the first direction from the spacer main body;
the second wall is positioned on one side in a third direction intersecting the first direction and the second direction, relative to the first wall; and
the energy storage assembly includes, on the other side in the first direction of the first wall, a first opening which connects a first space between the spacer main body and the second energy storage device with an external space outside the energy storage assembly.

2. The energy storage apparatus according to claim 1, wherein the first wall and the second wall are positioned at different positions in the second direction.

3. The energy storage apparatus according to claim 2, wherein at least a portion of the first wall and at least a portion of the second wall are positioned at a same position in the third direction.

4. The energy storage apparatus according to claim 1, wherein a length of the first wall in the third direction is greater than a length of the second wall in the third direction.

5. The energy storage apparatus according to claim 1, wherein
the spacer further includes a third wall positioned on the one side in the third direction relative to the second wall, the third wall protruding on the one side in the first direction from the spacer main body and being opposed to the first energy storage device in the second direction; and
the energy storage assembly further includes, on the other side in the first direction of the third wall, a second opening which connects a second space between the spacer main body and the second energy storage device with the external space.

6. The energy storage apparatus according to claim 1, wherein the first wall is positioned such that an edge thereof on the one side in the first direction overlaps the first energy storage device when viewed in the second direction.

7. The energy storage apparatus according to claim 1, further comprising:
a case including a case wall on the one side in the second direction; wherein
the case accommodates the energy storage assembly therein; and
the first wall includes a first convex portion protruding toward the case wall.

8. The energy storage apparatus according to claim 7, wherein the first convex portion does not overlap the spacer main body when viewed in the second direction.

9. The energy storage apparatus according to claim 1, wherein the first space defines a flow path for fluid to flow between the spacer main body and the first energy storage device.

10. The energy storage apparatus according to claim 1, wherein the first space is a space in a groove portion defined by a plurality of ribs provided on a surface of the spacer main body.

11. The energy storage apparatus according to claim 1, wherein the first space includes an elongated portion and a curved portion.

12. The energy storage apparatus according to claim 5, wherein the second space defines a flow path for fluid to flow between the spacer main body and the second energy storage device.

13. The energy storage apparatus according to claim 5, wherein the second space is a space in a groove portion defined by a plurality of ribs on a surface of the spacer main body.

14. The energy storage apparatus according to claim 5, wherein the second space includes an elongated portion and a curved portion.

15. The energy storage apparatus according to claim 1, wherein the first wall includes a reinforcing rib.

16. The energy storage apparatus according to claim 1, wherein the second wall includes a reinforcing rib.

17. The energy storage apparatus according to claim 5, wherein the third wall includes a reinforcing rib.

18. The energy storage apparatus according to claim 1, wherein no restraint is provided to restrain the first and second energy storage devices and the spacer.

19. The energy storage apparatus according to claim 7, wherein the spacer is movable within the case.

20. The energy storage apparatus according to claim 7, wherein the first wall and the second wall are not in surface contact with the case wall.
